(19) United States
(12) Patent Application Publication
(10) Pub. No.: US 2026/0289441 A1
(43) Pub. Date: Sep. 24, 2026

(54) SYSTEM

(71) Applicant: SoftBank Group Corp., Tokyo (JP)

(72) Inventor: Mai IKEDA, Tokyo (JP)

(73) Assignee: SoftBank Group Corp., Tokyo (JP)

(21) Appl. No.: 19/567,514

(22) Filed: Mar. 16, 2026

(30) Foreign Application Priority Data
Mar. 19, 2025 (JP) 2025-045083

(51) Int. Cl. G06Q 10/0631

(52) U.S. Cl. CPC G06Q 10/0631

(57) ABSTRACT

A system includes a processor that is configured to obtain and record transaction information of a user, cause, based on a prompt, a generative AI model to read an image of a receipt captured by an image capturing device and perform image analysis on the image of the receipt, and generate cooking procedures based on a result analyzed by the generative AI model.

### CROSS-REFERENCE TO RELATED APPLICATION

This application is based on and claims priority under 35 USC 119 from Japanese Patent Application No. 2025-045083 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that manage user purchases and propose cooking methods typically rely on fixed rule-based logic or manually curated recipe databases. Such systems are unable to fully utilize the detailed information contained in receipts, and cannot flexibly generate cooking procedures tailored to the actual types and amounts of ingredients purchased by each user. As a result, users may not obtain appropriate recipe suggestions that match their real-time inventory, leading to inefficient use of purchased items and potential food waste.

Furthermore, conventional reminder systems for consumable items, such as shampoo or detergent, generally trigger notifications based only on simple thresholds such as elapsed days or estimated usage rates. These systems do not consider the emotional state of the user when deciding the timing or manner of notifications. Consequently, reminders may be issued at moments when the user is stressed, tired, or otherwise in an unsuitable emotional state, which can reduce user satisfaction and may cause users to disable or ignore the notifications altogether.

Accordingly, there is a need for a system that: (i) acquires and records user transaction information, (ii) uses generative AI models to analyze receipt images and generate cooking procedures dynamically based on the analysis results, and (iii) predicts items that are likely to become insufficient while also adjusting the timing of notifications in consideration of the user's emotional state. Such a system would improve the usability and effectiveness of both recipe generation and consumable management.

### SUMMARY

In order to solve the above-described problems, according to one aspect of the present invention, there is provided a system comprising a processor, wherein the processor is configured to obtain and record transaction information of a user. The processor is further configured to cause, based on a prompt, a generative AI model to read an image of a receipt captured by an image capturing device and perform image analysis on the image of the receipt. The processor is also configured to generate cooking procedures based on a result analyzed by the generative AI model. By using a generative AI model driven by prompts, the system can flexibly interpret the content of various store receipts, recognize purchased items and their quantities, and dynamically produce cooking procedures that are adapted to the user's actual purchases.

In one embodiment, the processor is configured to generate a prompt that instructs the generative AI model to analyze a type and an amount of an item purchased as indicated on the captured image of the receipt, and input the prompt to the generative AI model. This enables precise extraction of structured information from unstructured receipt images, improving the accuracy of ingredient recognition and allowing for the generation of more suitable recipes.

In another embodiment, the processor is configured to predict an item that is likely to become insufficient based on a usage history and an inventory status, analyze an emotional state of the user by using an emotion analysis engine, and adjust timing of a notification in consideration of a result of the emotional state analysis. By combining prediction of low-stock items with analysis of the user's emotional state, the system can send reminders at times when the user is more receptive, thereby increasing the likelihood that the user will respond positively to the notification and improving overall user experience.

The term “system” refers to an arrangement of hardware and software components, including at least one processor and associated memories, storage, communication interfaces, and peripheral devices, that cooperatively execute functions described in the present specification.

The term “processor” refers to a hardware processing unit, such as a central processing unit (CPU), graphics processing unit (GPU), digital signal processor (DSP), application specific integrated circuit (ASIC), or field programmable gate array (FPGA), or a combination thereof, that executes computer-readable instructions to perform the functions described in the present specification.

The term “transaction information” refers to information related to a user's purchase or financial transaction, including, but not limited to, date and time of purchase, store identifier, purchased item identifiers, quantities, unit prices, total amounts, and payment method details, which can be obtained from receipts, payment services, or point-of-sale systems.

The term “receipt” refers to a document, whether printed or displayed electronically, that records details of one or more transactions, including at least a list of purchased items and corresponding quantities and/or prices, and that can be captured as an image by an image capturing device.

The term “image capturing device” refers to a device capable of acquiring a digital image of a physical object, such as a camera integrated into a smartphone, tablet, personal computer, or dedicated imaging apparatus, and providing the captured image to the system.

The term “image of a receipt” refers to digital image data obtained by capturing, via an image capturing device, a visual representation of a receipt that contains text or symbols indicating transaction-related information.

The term “generative AI model” refers to a machine-learning model, such as a neural network-based model, that is configured to generate output data, including but not limited to text, based on input data and a prompt, and that can perform tasks such as image analysis, text generation, classification, and extraction of structured information.

The term “prompt” refers to input data, including instructions, examples, and context information, provided to the generative AI model in order to define or guide the processing to be performed by the generative AI model and to influence the format or content of the output generated by the generative AI model.

The term “image analysis” refers to processing performed on an image of a receipt by using the generative AI model or other algorithms to extract or interpret information, including text, item names, quantities, prices, or layout, from the image.

The term “cooking procedures” refers to one or more sequences of operations, including instructions, steps, ingredient lists, quantities, preparation methods, and cooking times, generated for preparing a dish or meal based on recognized items and quantities derived from the analysis result of the generative AI model.

The term “type of an item” refers to a classification or identification of an item purchased by the user, such as a product name, generic name, or category (for example, tomato, mozzarella cheese, shampoo), which is recognizable from the receipt.

The term “amount of an item” refers to a quantitative value associated with a purchased item, including, but not limited to, numerical quantity, weight, volume, number of units, or other measurable indication of the purchased item as expressed on the receipt.

The term “usage history” refers to recorded information about how and when a user has consumed or used items over time, including consumption dates, consumed amounts, and consumption patterns inferred or reported by the user or determined by the system.

The term “inventory status” refers to information indicating current or estimated remaining quantities of items available to the user, including stock levels, item identifiers, and associated timestamps, maintained by the system based on purchases and consumption.

The term “item that is likely to become insufficient” refers to an item for which the system predicts, based on the usage history and inventory status, that the remaining quantity will fall below a predetermined threshold within a predetermined period of time.

The term “emotion analysis engine” refers to a software and/or hardware module configured to analyze data related to the user, such as text, voice, facial expressions, physiological signals, or interaction logs, in order to estimate or classify an emotional state of the user.

The term “emotional state of the user” refers to an estimated psychological or affective condition of the user, such as stress level, happiness, fatigue, or irritation, as determined or inferred by the emotion analysis engine from available user-related data.

The term “notification” refers to information presented to the user, by way of a terminal or other output device, for the purpose of informing the user about a predicted insufficiency of an item, a recommended action, or other system-generated message.

The term “timing of a notification” refers to a point in time or a time period at which the system causes a notification to be output to the user, including scheduling or delaying the output based on factors such as usage prediction and the user's emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

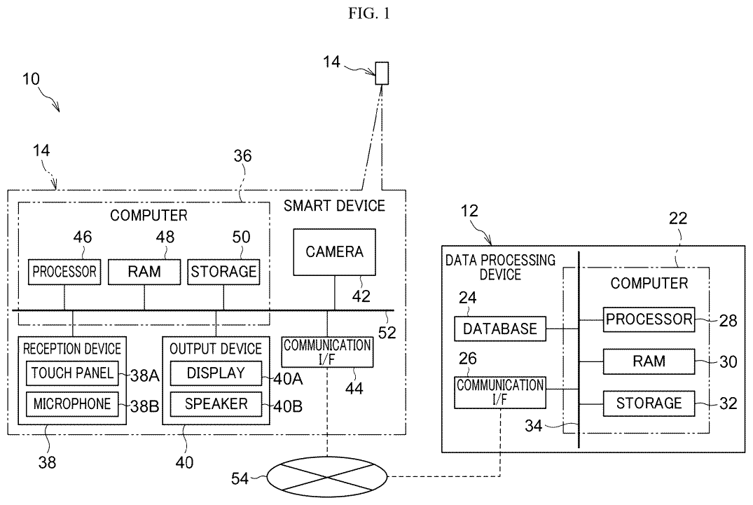

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

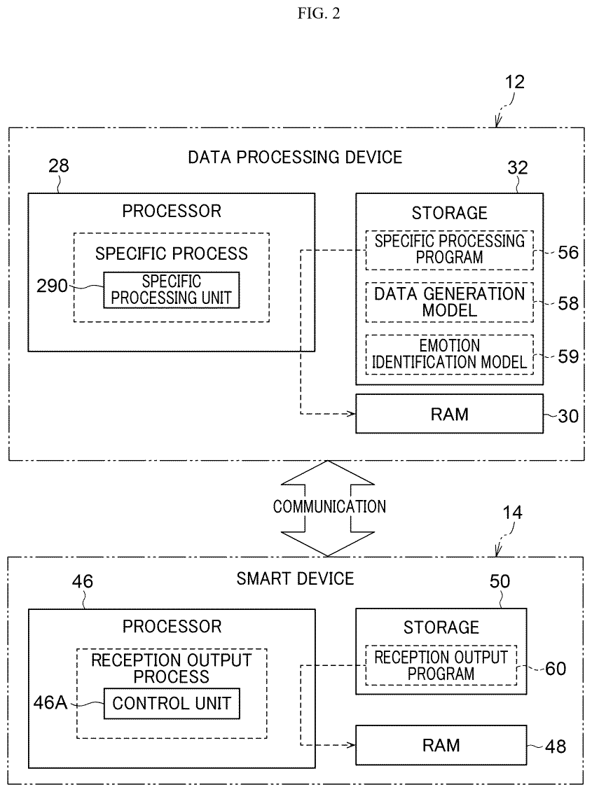

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional receipt-based cooking assistance and household resource management systems suffer from several technical shortcomings in the way they process image data, structure input for machine learning models, and manage the resulting data flows between components. In typical architectures, a receipt image is captured and then passed through a sequence of loosely coupled modules for optical character recognition (OCR), item extraction, and recipe suggestion. These modules often operate with rigid, hand-crafted rules and fixed data schemas. As a result, they exhibit low robustness to recognition errors, heterogeneous receipt formats, and varying user preferences. Furthermore, conventional systems generally treat a generative AI model, if used at all, as an opaque text generator that receives unstructured prompts, without systematic control over prompt composition or validation of the generated output.

From a computing-technology standpoint, these limitations manifest as inefficient utilization of processing resources, increased latency, and brittle end-to-end workflows. Because the system does not dynamically adapt the prompt sentences fed into the generative AI model based on structured resource management information and user context, a significant amount of server-side post-processing is required to correct, filter, or regenerate outputs. This leads to redundant computations, unnecessary network calls to AI inference services, and increased memory and storage operations. In addition, conventional systems do not tightly integrate inventory updates, shortage prediction, and notification timing control with the generative AI pipeline, resulting in fragmented data management, inconsistent states in databases, and difficulty in scaling the system across a large number of users and transactions.

Moreover, existing approaches typically perform OCR and item parsing as separate, linear steps that are not feedback-controlled. Errors in early stages propagate downstream and cause inaccurate inventory updates and unsuitable recipe generation, which then require manual correction by the user. This lack of closed-loop control prevents the system from automatically reformulating prompts, re-invoking the generative AI model, or adjusting the processing sequence to mitigate data-quality issues. Consequently, the overall computer system exhibits poor fault tolerance, degraded user experience, and suboptimal performance in terms of CPU load, network bandwidth usage, and storage efficiency.

Therefore, there is a need for an improved computer-implemented system that tightly integrates receipt image preprocessing, structured extraction of transaction information, dynamic construction and validation of prompt sentences for a generative AI model, and automated updates to resource management information. Such a system should provide a technically enhanced control flow that reduces redundant processing, improves robustness to recognition errors, and enables more efficient use of computational and storage resources while delivering consistent, machine-usable outputs for cooking procedure generation and resource shortage prediction.

The specific processing by the specific processing unit 290 of the data processing device 12 in Example 1 is realized by the following means.

The present invention provides a server comprising a processor configured to acquire and record transaction-related information of a user, to perform preprocessing on image data of a transaction proof acquired by an image input device, to generate a prompt sentence for causing a generative AI model to read the image data of the transaction proof, and to control input of the prompt sentence and the image data into the generative AI model; to perform character recognition processing and structural analysis processing on character information output from the generative AI model, to extract purchased items, quantities, and prices from the character information, and to update resource management information on the basis of the extracted items and quantities; to select a combination of items available for cooking from the resource management information, to generate a prompt sentence for instructing the generative AI model to generate a cooking procedure on the basis of the combination of the items and attribute information or preference information of the user, and to control input of the prompt sentence into the generative AI model; to format information relating to the cooking procedure output from the generative AI model into a predetermined format, to calculate consumption amounts of resources corresponding to the cooking procedure, to update the resource management information on the basis of the consumption amounts, and to output the cooking procedure to an information display device; to predict future shortages of resources on the basis of the resource management information and the information relating to the cooking procedure, to generate a prompt sentence for instructing the generative AI model to generate proposal information on the basis of predicted shortage resources and behavior history or state information of the user, to determine notification content and transmission timing in accordance with the proposal information, and to output the notification content at the determined transmission timing to the information display device or a notification device; and to dynamically configure the prompt sentence input to the generative AI model by combining a plurality of kinds of information including item names and quantities extracted from the image of the transaction proof, the resource management information, the attribute information or preference information of the user, cooking condition information, and notification condition information, to verify a structure and items of an output result from the generative AI model, and, when a deficiency is detected, to automatically correct the prompt sentence and re-input the corrected prompt sentence to the generative AI model. This enables an improved computer-implemented pipeline in which receipt image data, extracted transaction information, resource management records, and user context are integrated into a closed-loop control of prompt generation and validation for the generative AI model, thereby reducing redundant processing, improving robustness to recognition and generation errors, maintaining consistent and up-to-date resource information, and enhancing overall system efficiency in terms of processing load, storage operations, and network usage.

The term “transaction-related information” refers to digital data representing economic activities of a user, including but not limited to purchase records, payment records, dates and times of transactions, identifiers of transaction proofs, and associated monetary amounts.

The term “user” refers to a person, household, or entity that conducts transactions, provides input to the system, and is the subject of resource management, cooking procedure generation, and notification control performed by the system.

The term “image input device” refers to an electronic device or component capable of capturing image data of a physical object, such as a camera module in a mobile terminal, a dedicated scanner, or an imaging sensor in a computing device.

The term “transaction proof” refers to a physical or electronic document that evidences a transaction, including but not limited to a receipt, invoice, bill, or similar record containing itemized information of purchased goods or services.

The term “image data” refers to digital data representing visual information obtained from a transaction proof by the image input device, including pixel values stored in a file format such as a bitmap, compressed image, or similar representation.

The term “preprocessing” refers to a sequence of computational operations performed on image data prior to further analysis, including operations such as cropping, rotation correction, noise reduction, contrast adjustment, binarization, and other transformations that improve suitability for recognition or analysis.

The term “prompt sentence” refers to text data or structured natural language instructions that are generated by the processor and provided as input to a generative AI model to specify a task, a context, or constraints for processing, including tasks such as reading a transaction proof image or generating a cooking procedure.

The term “generative AI model” refers to a machine learning model, such as a neural network or language model, that generates output data including text or structured information in response to input data and a prompt sentence, based on learned statistical patterns from training data.

The term “character information” refers to textual data, including symbols, numbers, and alphanumeric characters, that is output from the generative AI model or a recognition engine and represents content extracted from a transaction proof.

The term “character recognition processing” refers to computational operations that interpret or refine character information, including operations such as decoding, error correction, and mapping recognized characters to standard character sets or vocabularies.

The term “structural analysis processing” refers to computational operations that analyze the layout and logical structure of character information, including identifying lines, fields, item records, and relationships among text segments within the transaction proof.

The term “purchased items” refers to goods or services that are identified from the character information as having been acquired in a transaction, including any consumable or non-consumable products listed on a transaction proof.

The term “quantities” refers to numerical values or counts associated with purchased items, such as the number of units, volume, weight, or other measurable amounts extracted from the character information.

The term “prices” refers to monetary values associated with purchased items, including unit prices, total prices per item, and aggregated totals, as extracted from the character information.

The term “resource management information” refers to structured data maintained by the system that represents the availability, usage, and status of resources associated with a user, including inventory quantities, consumption history, and related metadata for items.

The term “items available for cooking” refers to a subset of resources represented in the resource management information that are classified as suitable ingredients for preparing food or beverages and are currently available in sufficient quantity for use in a cooking procedure.

The term “attribute information of the user” refers to profile data associated with the user, including demographic information, dietary restrictions, cooking skill level, and other static or semi-static characteristics used to tailor system behavior.

The term “preference information of the user” refers to data representing the user's likes, dislikes, and choices regarding cooking, ingredients, flavors, or other options, derived from explicit settings, historical behavior, or learned patterns.

The term “cooking procedure” refers to a sequence of operations and instructions for preparing a dish or meal using specified items, including steps such as preparation, mixing, heating, and serving, and any associated parameters such as time and temperature.

The term “predetermined format” refers to a defined data structure or layout used to represent information in a consistent manner, such as a schema with fields for a title, ingredient list, and ordered steps in a cooking procedure.

The term “consumption amounts of resources” refers to quantities of items that are determined by the system to be used or depleted when the user follows a cooking procedure, and that are used to update the resource management information.

The term “information display device” refers to any electronic device or component capable of presenting information to a user, including a display of a mobile terminal, a monitor of a computer, or another visual output interface.

The term “notification device” refers to an electronic component or system capable of presenting alerts or notifications to a user, including but not limited to a terminal that displays messages, a device that generates sound or vibration, or a system that delivers push notifications.

The term “future shortages of resources” refers to predicted conditions in which quantities of certain resources represented in the resource management information are expected to fall below a predefined threshold at a future time.

The term “proposal information” refers to information generated based on predicted shortages and user context, including suggestions such as recommended purchases, alternative recipes, or resource usage plans that the system provides to the user.

The term “behavior history of the user” refers to logged records of the user's past interactions and actions within the system, including executed cooking procedures, accepted or rejected suggestions, and usage of resources over time.

The term “state information of the user” refers to data representing a current or recent condition associated with the user or the user's environment, such as time constraints, location, or device status, which may influence proposal generation or notification timing.

The term “cooking condition information” refers to data representing constraints or preferences related to cooking, such as available appliances, maximum cooking time, difficulty level, or dietary conditions.

The term “notification condition information” refers to data representing constraints or preferences related to notification behavior, such as preferred time windows, urgency levels, channels of communication, or frequency limits.

The term “dynamically configure” refers to performing computational operations at run time to construct or modify a prompt sentence or other data structure based on current inputs, states, or context, rather than relying solely on fixed or static templates.

The term “output result from the generative AI model” refers to data generated by the generative AI model in response to input data and a prompt sentence, including text, structured data, or other machine-usable representations.

The term “verify a structure and items” refers to checking an output result from the generative AI model against expected formats, required fields, and logical constraints, to determine whether the output satisfies predetermined structural and content requirements.

The term “deficiency” refers to a condition in which an output result from the generative AI model fails to meet predetermined requirements, such as missing fields, inconsistent values, incorrect structure, or other errors that prevent reliable use by the system.

In one embodiment, a server cooperates with a terminal operated by a user to implement the claimed system. The terminal is realized as a mobile computing device, such as a smartphone or a tablet, that includes a camera module, a display, a local storage unit, a wireless communication interface, and an execution environment for an application program. The server is realized as a network-accessible computing system that includes one or more processors, a main memory, a persistent storage unit, a communication interface, and optionally one or more accelerator devices such as graphics processing units. The server executes an operating system, a web application framework, a database management system, an image-processing library, an OCR engine, and a generative AI model implemented as a neural network.

The terminal captures image data of a transaction proof such as a receipt. The terminal uses the built-in camera hardware and a camera control program to adjust focus, exposure, and image stabilization. The terminal converts analog signals from the image sensor into digital pixel data and encodes the image into a compressed file such as a JPEG file. The terminal then performs preliminary image adjustments using general-purpose image-processing libraries provided by the operating system, such as cropping, rotation correction, and contrast adjustment. The terminal transmits the resulting image data to the server via a wireless communication link such as a cellular network or a wireless local area network, using an encrypted communication protocol.

The server receives the image data via the communication interface and stores it in persistent storage such as a solid-state storage unit or an object storage service. The server associates the stored image with a user identifier and a transaction identifier in a relational database management system. The server executes an image preprocessing module implemented with an image-processing library such as a library that performs grayscale conversion, noise reduction, perspective correction, and binarization. The server thereby generates a preprocessed bitmap that enhances text contrast and straightens the layout of lines, which improves the performance of subsequent recognition.

The server generates a first prompt sentence that describes the technical task to the generative AI model. In one example, the server constructs the following prompt sentence: “Read the attached receipt image. Extract each purchased item, its quantity, and its price from the receipt. Output the result as plain text lines in the format: [item name] [quantity] [price]. Ignore headers, footers, and non-item messages.”

The server embeds the prompt sentence and an encoded representation of the preprocessed image into the input of the generative AI model. The server implements the generative AI model as a multi-layer transformer-based neural network that accepts a sequence of tokens. The server tokenizes the prompt sentence into subword tokens and embeds the bitmap image by compressing it into a lower-dimensional feature representation using a convolutional encoder. The server concatenates text tokens and image feature tokens into a unified token sequence.

The server executes the generative AI model on an accelerator such as a graphics processing unit. The generative AI model includes multiple transformer layers, each comprising multi-head self-attention mechanisms and feed-forward sub-networks with non-linear activation functions. The server provides learned parameters of the model that have been trained in advance using supervised learning on a corpus of receipt images and corresponding structured item lists. During training, the server minimizes a loss function such as a cross-entropy loss between predicted tokens and ground-truth tokens using stochastic gradient descent, and the server updates the weights of the network by backpropagating partial derivatives through the transformer layers. The server optionally applies data augmentation during training, such as random rotation, noise injection, and brightness variation of receipt images, to improve robustness.

The server receives character information output by the generative AI model as a sequence of tokens. The server decodes the tokens into text lines that describe item names, quantities, and prices. The server performs additional character recognition processing and structural analysis processing on the decoded output. In one embodiment, the server executes a rule-based parser and a statistical parser in combination. The server uses regular expressions and lexical patterns to identify numeric substrings and currency symbols. The server also uses a statistical sequence model, such as a conditional random field, to label segments as item name, quantity, or price. The server then constructs structured records that represent purchased items, including fields for a canonical item identifier, a quantity expressed in a normalized unit, and a unit price.

The server normalizes item names by comparing textual item names against records in a product master table stored in the relational database. The server uses fuzzy string matching algorithms, such as approximate string distance measures, and optionally a smaller neural embedding model that maps item names into a vector space to find similar known products. The server resolves ambiguous matches by applying priority rules and contextual information, such as store identifier and category codes, stored in the database. The server thereby reduces variation in item naming and improves the consistency of resource management information.

The server updates resource management information stored in the database. The server maintains an inventory table that stores, for each user, item identifiers, current quantities, last purchase dates, and predicted expiration dates. The server increments quantities for items that already exist in the inventory and inserts new records for newly recognized items. The server records the relationship between the receipt and the inventory changes through foreign key associations. This structured update improves the consistency of data and avoids redundant storage of similar items.

The server selects items available for cooking based on the updated resource management information. The server executes a selection module that filters items according to classification codes indicating edibility, storage conditions, and current availability. The server optionally considers conditions such as minimum quantity thresholds and expiration dates. The server then constructs an ingredient set that can be used as input to generate a cooking procedure.

The server generates a second prompt sentence that instructs the generative AI model to produce a cooking procedure. In one example, the server constructs the following prompt sentence:

“The user has the following ingredients: 2 tomatoes, 1 pack of mozzarella cheese, and a small amount of basil. Using only these ingredients plus common pantry items (salt, pepper, olive oil), propose a recipe and provide detailed, step-by-step cooking instructions suitable for a beginner.”

The server incorporates additional information into the prompt sentence, such as the user's cooking skill level, dietary preferences, and maximum cooking time, which the server obtains from attribute information and preference information stored in the database. The server thereby dynamically configures the prompt sentence rather than using a fixed template.

The server tokenizes the second prompt sentence and feeds it into the generative AI model. The generative AI model processes the token sequence through transformer layers and computes next-token probabilities at each step. The server samples or decodes tokens according to a decoding strategy such as beam search or nucleus sampling. The server controls parameters such as temperature and maximum length to balance creativity and determinism. The server obtains generated text that typically includes a recipe title, an ingredient list, and sequential instructions.

The server verifies the structure and content of the generated cooking procedure. The server implements an output validation module that parses the generated text into sections. The server checks for the presence of required sections, such as at least one recipe title and at least one instruction step. The server also ensures that the generated ingredient list is consistent with the items available for cooking. For example, the server detects if the generative AI model introduces ingredients that are not present in the inventory and not permitted by prompt constraints. If the server detects missing sections or unauthorized ingredients, the server constructs a refined prompt sentence, such as:

“The previous answer was incomplete or included ingredients that are not allowed. Please respond with: 1. Recipe Title; 2. Ingredients (only from the provided list); 3. Step-by-step Instructions.”

The server then re-executes the generative AI model with the refined prompt sentence. This closed-loop validation and re-prompting mechanism reduces the need for manual correction and improves the reliability of generated content.

The server formats the validated cooking procedure into a predetermined data structure. The server maps the title, ingredients, and steps into schema fields stored as structured records in the database. The server calculates consumption amounts of resources on the basis of ingredient quantities used in the cooking procedure. The server subtracts these amounts from the inventory table and records a cooking event in a history table. This structured update ensures that inventory levels remain coherent with generated recipes.

The server further predicts future shortages of resources by analyzing the resource management information and cooking history. The server implements a prediction module that uses a combination of rule-based thresholds and statistical models. For example, the server computes expected consumption rates for each item by dividing historical consumption quantities by time intervals. The server compares projected inventory levels against shortage thresholds at future time points. When the server predicts a shortage, the server constructs another prompt sentence that instructs the generative AI model to generate proposal information. In one example, the server constructs the following prompt sentence: “The user is expected to run out of tomatoes and eggs within three days based on current inventory and past usage. Propose which items the user should purchase and suggest at least one simple recipe that uses items to be purchased together with currently remaining ingredients.”

The server also takes into account behavior history and state information of the user when determining notification timing. For example, the server observes typical times of day when the user interacts with the terminal and avoids sending notifications during undesired time windows. The server outputs the notification content at selected times to the terminal or to a dedicated notification device. This control reduces unnecessary notifications and optimizes communication load.

The terminal receives the cooking procedure and proposal information from the server and displays them on a graphical user interface. The terminal parses structured data and renders a screen showing the recipe title, ingredient list, and step-by-step instructions. The terminal allows the user to mark steps as completed and to access additional details. When the user confirms that a recipe has been executed, the terminal sends a completion signal to the server, which triggers inventory updates and potentially another prediction cycle.

The technical configuration described above provides several improvements to computer technology. The server integrates image preprocessing, neural-network-based recognition, structured parsing, dynamic prompt generation, and closed-loop validation into a unified pipeline. This integration reduces redundant server calls to external services because the system actively validates and corrects outputs at the server side before presenting them to the user. The use of a transformer-based generative AI model that simultaneously processes prompt sentences and encoded image features allows the server to perform OCR-like operations and semantic extraction in a single inference pass, which reduces latency compared to separate OCR and natural-language post-processing modules. The dynamic prompt configuration that combines resource management information, user attributes, cooking conditions, and notification conditions enables the generative AI model to produce more structured and context-appropriate outputs, thereby decreasing the amount of post-processing and reducing processor and memory usage.

The server employs non-conventional control logic for the generative AI model, including automatic prompt refinement and re-input based on structural verification of generated outputs. This control technique differs from merely automating human steps because the system uses machine-readable constraints, database-driven consistency checks, and structured schemas to systematically improve the quality of outputs and maintain data integrity. The server thus implements a specific, technical feedback loop that optimizes inference calls and reduces error propagation in subsequent modules.

The server can be implemented in alternative configurations. In one variation, the server uses a dedicated OCR engine separate from the generative AI model to perform low-level character recognition and uses the generative AI model primarily for semantic parsing and recipe generation. In another variation, the server uses multiple specialized generative AI models, such as one model tuned for receipt parsing and another model tuned for recipe generation, and the server orchestrates the models using distinct prompt sentences tailored to each task. In yet another variation, the server deploys the generative AI model on different hardware platforms, such as a central processing unit cluster or a specialized accelerator device, depending on performance and cost requirements.

The terminal can also be implemented in different forms. In one embodiment, the terminal is a dedicated kitchen device with an integrated display, a camera, and a voice interface. In another embodiment, the terminal is a general-purpose computing device such as a laptop or a desktop computer equipped with a webcam. In all cases, the terminal cooperates with the server through network communication to acquire transaction proof images, display generated cooking procedures, and report user actions.

Through these configurations, the server and the terminal cooperate to implement a system that not only automates receipt processing and recipe suggestion but also improves the underlying computer processes involved in image analysis, data normalization, inventory management, neural-network inference control, and notification scheduling. The system thereby achieves enhanced processing speed, higher recognition and generation accuracy, reduced communication overhead, and improved consistency of stored data compared with conventional systems that lack such integrated, feedback-controlled generative AI processing.

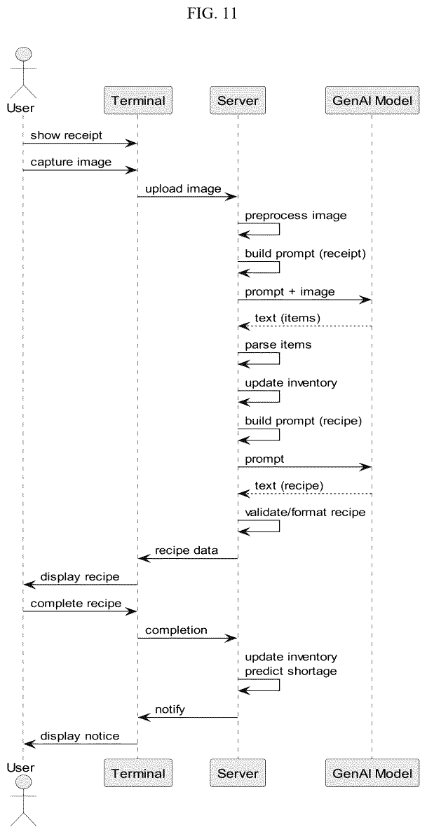

The following describes the processing flow using FIG. 11.

### Step 1

The user prepares a physical transaction proof such as a paper receipt.

Input: A physical receipt containing printed characters that describe purchased items, quantities, and prices.

Output: None in digital form at this step.

The user holds the receipt in front of the terminal's camera under sufficient lighting and positions the receipt so that the entire document is within the camera's field of view.

### Step 2

The terminal captures image data of the receipt using a built-in camera module. Input: Optical information from the physical receipt (light reflected from the surface). Output: Raw digital image data (for example, a high-resolution RGB bitmap).

The terminal controls the camera sensor to adjust focus, exposure, and white balance. The terminal converts analog sensor signals into digital pixel values and buffers the image in memory. The terminal then encodes the bitmap into a compressed image format such as JPEG by executing a compression algorithm that reduces redundant color information and spatial correlation between pixels.

### Step 3

The terminal performs local image preprocessing on the captured image before transmission. Input: The compressed receipt image file generated in Step 2.

Output: A preprocessed and possibly re-encoded image file optimized for recognition and transmission.

The terminal crops the region that contains the receipt using edge detection and contour analysis provided by image-processing APIs. The terminal corrects rotation by estimating the skew angle from detected text lines and applying an affine transformation. The terminal adjusts contrast and brightness by rescaling pixel intensity histograms. The terminal then recompresses the processed bitmap at a selected quality level to reduce file size while preserving readability.

### Step 4

The terminal transmits the preprocessed image to the server over a network.

Input: The preprocessed receipt image file and user identification data.

Output: An HTTP or similar network request containing the image and metadata sent to the server.

The terminal opens a secure communication channel (for example, HTTPS) to a server endpoint. The terminal attaches an authentication token, device identifier, and timestamp to the request headers or body. The terminal embeds the preprocessed image as multipart data or as a binary payload. The terminal sends the request and waits for a response acknowledging receipt.

### Step 5

The server receives and stores the receipt image and associated metadata.

Input: The network request from the terminal containing the image file and user information.

Output: A stored image object and a new database record referencing the transaction.

The server validates the authentication token and verifies the user's access rights. The server writes the image file into persistent storage such as a file system or object store. The server creates a transaction record in a relational database, storing fields such as user identifier, file path to the image, reception time, and processing status. The server commits the record to ensure durability.

### Step 6

The server preprocesses the stored receipt image for analysis by the generative AI model.

Input: The stored image file path or binary image data retrieved from storage.

Output: A normalized bitmap ready for feature extraction and tokenization.

The server uses an image-processing library to load the image into memory and converts it to grayscale to reduce data dimensionality. The server applies noise reduction filters such as median filtering to remove small artifacts. The server performs perspective and skew correction on the basis of detected rectangular contours and text line orientations. The server executes binarization, mapping each pixel to black or white using an adaptive threshold, to accentuate characters and suppress background noise.

### Step 7

The server generates a first prompt sentence instructing the generative AI model to interpret the receipt image.

Input: Metadata describing the receipt (for example, store type, language information) and system rules for item extraction.

Output: A textual prompt sentence that encodes the extraction task.

The server selects a template for receipt parsing and fills placeholders with context parameters. For example, the server constructs the following prompt sentence: “Read the attached receipt image. Extract each purchased item, its quantity, and its price from the receipt. Output the result as plain text lines in the format: [item name] [quantity] [price]. Ignore headers, footers, and non-item messages.”

The server stores this prompt sentence in memory and associates it with the current transaction context.

### Step 8

The server encodes the receipt image and prompt sentence into an input sequence for the generative AI model.

Input: The normalized bitmap from Step 6 and the prompt sentence from Step 7.

Output: A token sequence or combined representation suitable for transformer-based inference.

The server tokenizes the prompt sentence into subword tokens using a pre-defined vocabulary. The server passes the bitmap through a convolutional feature extractor or a similar encoder that reduces the image into a series of feature vectors. The server concatenates text token embeddings and image feature embeddings into a unified sequence.

The server arranges positional encodings to preserve the order of tokens and spatial information from the image.

### Step 9

The server executes the generative AI model to obtain character information representing the receipt contents.

Input: The unified sequence of token and image embeddings from Step 8.

Output: A sequence of output tokens representing extracted items, quantities, and prices as text.

The server runs the transformer-based generative AI model on a processor or hardware accelerator. The model performs self-attention operations to compute interactions between textual tokens and image-derived tokens. Each transformer layer applies linear projections, non-linear activations, and normalization operations to refine representations. The server decodes the final layer's output into token probabilities and uses a decoding strategy such as greedy decoding to select the most likely token at each position. The server converts the resulting token sequence back into human-readable text lines.

### Step 10

The server performs character recognition refinement and structural analysis on the generative AI output.

Input: Text lines generated by the generative AI model in Step 9.

Output: Structured item records containing item names, quantities, and prices.

The server applies regular expressions to segment each line into candidate item name, quantity, and price fields. The server uses a lexical dictionary to normalize currency symbols and units. The server uses a statistical or rule-based tagger to identify the position of each field in ambiguous lines. The server then builds an item record for each line, including fields such as raw item name, parsed quantity value, unit type, unit price, and total price.

### Step 11

The server normalizes item names and quantities and updates resource management information.

Input: Structured item records from Step 10 and existing inventory data from the database.

Output: Updated resource management records reflecting current inventory.

The server queries a product master table to find canonical product identifiers corresponding to raw item names. The server uses fuzzy matching techniques to calculate similarity scores between raw names and stored names, then selects the best match above a threshold. The server converts quantities into standardized units by applying conversion factors (for example, converting “2 packs” into “2 units” with a unit code). The server inserts new inventory entries or updates existing entries by incrementing quantities. The server records links between the receipt, inventory records, and user identifier.

### Step 12

The server selects items available for cooking based on current resource management information.

Input: Updated inventory records and classification attributes for each item.

Output: A subset of items and their quantities suitable for use as ingredients.

The server filters inventory entries whose item types are classified as edible and currently in stock above a minimum threshold. The server excludes items marked as expired or reserved. The server may apply additional selection criteria based on the user's dietary restrictions and preferences, retrieving such information from user profile tables. The server constructs an ingredient list that includes item names, normalized quantities, and any relevant attributes.

### Step 13

The server generates a second prompt sentence for cooking procedure generation using the generative AI model.

Input: The selected ingredient list from Step 12 and user attribute and preference information from the database.

Output: A textual prompt sentence describing the recipe generation task.

The server composes a natural language instruction that encodes available ingredients and constraints. For example, the server may generate:

“The user has the following ingredients: 2 tomatoes, 1 pack of mozzarella cheese, and a small amount of basil. Using only these ingredients plus common pantry items (salt, pepper, olive oil), propose a recipe and provide detailed, step-by-step cooking instructions suitable for a beginner.”

The server may append conditions such as “within 20 minutes” or “without using an oven” depending on stored user preferences.

### Step 14

The server encodes the second prompt sentence and performs generative inference for recipe creation.

Input: The second prompt sentence from Step 13.

Output: Generated text comprising a candidate recipe, including title, ingredients, and steps.

The server tokenizes the prompt sentence into a sequence of tokens. The server feeds the tokens into the generative AI model configured for text generation. The model processes the sequence through multiple transformer layers, computing contextual representations for each token. The server then decodes the model's prediction of subsequent tokens using a decoding strategy such as beam search, generating coherent text that describes a recipe title, a list of ingredients, and step-by-step instructions.

### Step 15

The server validates the structure and consistency of the generated cooking procedure.

Input: Generated recipe text from Step 14 and the ingredient list from Step 12.

Output: A validated and, if necessary, regenerated cooking procedure text.

The server parses the generated text to identify sections such as “Title,” “Ingredients,” and “Steps.” The server checks that at least one item is present in each required section and that all ingredients used in the steps correspond to items in the supplied ingredient list. The server flags any occurrence of an ingredient not present in the inventory or forbidden by user preferences. If the server detects missing sections or inconsistent ingredient usage, the server generates a refined prompt sentence that instructs the generative AI model to correct the issues, and the server performs another inference call. The server repeats this loop until the recipe satisfies predefined structural and consistency conditions.

### Step 16

The server formats the validated recipe into a predetermined data structure and updates inventory consumption.

Input: The validated recipe text from Step 15 and the existing inventory records.

Output: Structured recipe records and updated resource management information reflecting consumed items.

The server extracts the recipe title, ingredients, and ordered steps into a structured representation such as a set of relational tables or a predefined schema. The server calculates the consumption amounts of each ingredient by parsing quantity indications in the recipe. The server subtracts these amounts from inventory quantities stored in the resource management table. The server inserts a record in a cooking history table that links the recipe, the user, and the consumption event.

### Step 17

The server predicts future resource shortages and prepares notification content.

Input: Updated resource management information and cooking history data.

Output: Predicted shortage records and associated notification messages.

The server runs a prediction algorithm that analyzes historical consumption rates for each item. The server calculates an expected depletion date by dividing current inventory quantities by average daily or weekly usage. The server compares predicted depletion dates with user-defined thresholds to identify items that will soon be depleted. For such items, the server constructs a prompt sentence such as:

“The user is expected to run out of tomatoes and eggs within three days based on current inventory and past usage. Propose which items the user should purchase and suggest at least one simple recipe that uses items to be purchased together with currently remaining ingredients.”

The server may invoke the generative AI model again to generate proposal information, then composes notification messages that summarize the proposals.

### Step 18

The server determines notification timing based on user behavior history and state information and sends data to the terminal.

Input: Notification messages from Step 17, user behavior history, and user state information.

Output: Notification payloads transmitted to the terminal at determined times.

The server analyzes historical logs to identify typical time windows when the user responds to notifications. The server excludes time windows marked as undesirable by user settings. The server schedules notifications accordingly and sends them through a push notification service or direct server-to-terminal communication. The server includes in the payload references to recipes, suggested purchases, and any relevant context.

### Step 19

The terminal receives and displays the cooking procedure and notifications to the user.

Input: Recipe data and notification payloads from the server.

Output: Visual representations of recipes, alerts, and suggested actions on the terminal display.

The terminal parses structured recipe data to populate user interface components such as a title area, ingredient list, and numbered instruction list. The terminal renders notifications in a dedicated area or system notification tray. The terminal allows the user to open a notification and directly navigate to the detailed recipe or suggestion screen. The terminal may provide interactive controls for marking steps as completed or for confirming that a suggested purchase or recipe has been accepted.

### Step 20

The user interacts with the terminal to follow recipes and respond to notifications.

Input: Displayed cooking procedures and notification messages.

Output: User actions such as confirmations, rejections, and completion signals transmitted to the server.

The user reads the recipe steps on the terminal, prepares ingredients, and executes the instructions. The user may tap buttons such as “Next step,” “Recipe completed,” or “Show another recipe.” The terminal captures these actions and sends corresponding events to the server. The server uses these events to refine inventory records, adjust consumption predictions, and update behavioral models used for future notification timing and prompt sentence configuration.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented household management and recipe recommendation systems suffer from several technical limitations that result in inefficient utilization of computational resources, fragmented data processing pipelines, and low-quality decision support for users.

First, typical systems process receipt images and inventory data in a siloed manner, often relying on fixed-format templates or rule-based parsing. As a result, such systems are brittle against layout variation, require extensive manual configuration, and generate noisy or incomplete structured data. This leads to repeated reprocessing of images, redundant storage of inconsistent item records, and increased load on storage and processing subsystems.

Second, known systems generally do not integrate a generative artificial intelligence model as a core component of the data normalization and content generation pipeline. Instead, they depend on static dictionaries and heuristics to map text to item records and to generate recipes or suggestions. This creates a technical bottleneck: each new store format or item description requires manual updates, and the system cannot dynamically generalize from noisy optical character recognition outputs. Consequently, the processor must perform multiple post-correction passes and complex business-logic rules, which degrades real-time performance and scalability.

Third, in conventional architectures, inventory management, shortage prediction, and recipe generation are usually implemented as independent functions that are loosely coupled, if at all. Data flows between these functions are often ad hoc and involve repeated querying, conversion, and aggregation of item records. This fragmented design results in unnecessary processing steps, increased memory usage, and latency in providing context-aware notifications or suggestions to the user terminal. For example, shortage prediction may not directly use fine-grained, normalized item data, and recipe generation may not fully exploit current inventory or expiration information.

Fourth, existing systems typically treat notifications and ordering flows as simple application-layer features, without deeply integrating them into the same structured-data pipeline that produces normalized items and inventory states. As a result, the system cannot efficiently generate notifications and external service order payloads from a unified, consistent representation of the user's inventory and usage history. This requires additional transformation layers and error-prone mappings, which consume processor cycles and network resources.

Fifth, in many systems, household-account aggregation is performed with coarse-grained transaction data (for example, total amounts only) and is not tightly linked to per-item normalized records. This prevents efficient query planning, indexing, and aggregation on item categories and undermines the ability of the processor to compute multidimensional summaries (by category, by time, by usage) without executing expensive, repetitive joins and ad hoc parsing logic.

Accordingly, there is a need for an improved computer-implemented system and server-side architecture in which a processor is specifically configured to: (i) transform unstructured receipt image data into normalized inventory records by coordinating image processing, optical character recognition, and a generative artificial intelligence model via structured prompt sentences; (ii) maintain a unified data schema that simultaneously supports inventory management, household-account aggregation, shortage prediction, and recipe generation; and (iii) generate notifications and external delivery order information directly from this unified data model. Such an architecture improves the technical functioning of the computer system by reducing redundant processing, simplifying data transformations, and enabling the processor to execute fewer, more efficient operations, thereby improving throughput, latency, and scalability of the overall system.

The specific processing by the specific processing unit 290 of the data processing device 12 in Application Example 1 is realized by the following means.

The present invention provides a server comprising a processor configured to acquire transaction information of a user and record the transaction information as household management information; receive, from a user terminal, image data of a transaction evidence document captured by an imaging device; apply image processing and character recognition to the image data to extract character string data; generate a prompt sentence including the character string data; input the prompt sentence into a generative artificial intelligence model so as to cause the generative artificial intelligence model to output normalized item information including item names, quantities, and units; store the normalized item information as inventory management information in a unified data structure; generate, based on the inventory management information and past usage history information, a further prompt sentence for causing the generative artificial intelligence model to generate cooking procedure information using inventory items; input the further prompt sentence into the generative artificial intelligence model; acquire the cooking procedure information output from the generative artificial intelligence model; provide the cooking procedure information to the user terminal; specify items predicted to become insufficient in the future based on the inventory management information and the usage history information; generate notification information regarding the predicted insufficient items and transmit the notification information to the user terminal; classify the normalized item information into expenditure category information as part of the household management information; compute aggregation results based on the expenditure category information; provide the aggregation results to the user terminal; extract, from the inventory management information, items having an expiration date approaching and items having a remaining amount equal to or smaller than a threshold; generate an additional prompt sentence for causing the generative artificial intelligence model to generate cooking procedure information that preferentially uses the extracted items; input the additional prompt sentence into the generative artificial intelligence model; acquire the cooking procedure information output from the generative artificial intelligence model; and generate and transmit order information to an external information processing apparatus for a delivery service based on at least one of the cooking procedure information and the inventory management information. This enables the server to implement an integrated and technically efficient pipeline in which unstructured receipt images are converted into normalized inventory and expenditure records through coordinated use of image processing, character recognition, and a generative artificial intelligence model; in which recipe generation, household-account aggregation, shortage prediction, and delivery ordering are all performed from a unified data representation; and in which the number of processing stages, data transformations, and network transactions required to support inventory-aware notifications and content generation is reduced, thereby improving computational efficiency, responsiveness, and scalability of the computer system.

The term “transaction information” refers to data representing one or more commercial transactions of a user, including at least a transaction date, a transaction amount, and optionally a merchant identifier, payment method information, and item-level purchase details.

The term “household management information” refers to structured data representing financial and consumption-related information for a user or household, including transaction information, categorized expenditure information, and derived statistical or aggregation results used for budgeting or expense tracking.

The term “transaction evidence document” refers to a document that evidences a commercial transaction, including but not limited to a receipt, an invoice, or an electronic proof-of-purchase, and that can be captured as image data by an imaging device.

The term “imaging device” refers to a hardware component capable of capturing image data, such as a digital camera, a camera module integrated into a portable terminal, or a scanner.

The term “image data” refers to digital data representing at least one image frame, including, for example, a bitmap, raster data, or a compressed image file that depicts a transaction evidence document.

The term “image processing” refers to operations performed on image data to improve or extract visual features, including but not limited to scaling, rotation, perspective correction, noise reduction, binarization, and contrast adjustment.

The term “character recognition” refers to a process of analyzing image data to detect and recognize alphanumeric characters, symbols, or text segments, and to output corresponding character string data.

The term “character string data” refers to text data obtained from a transaction evidence document by character recognition, including lines, words, or tokens that describe purchased items, quantities, prices, merchants, and other transaction details.

The term “prompt sentence” refers to a machine-readable instruction or query, expressed in natural or formal language, that is constructed to be input to a generative artificial intelligence model and that specifies at least a task description and task-related data.

The term “generative artificial intelligence model” refers to a computational model, implemented in software and executed on one or more processors, that is trained on data and configured to generate output content, such as structured data or natural-language text, in response to an input prompt sentence.

The term “normalized item information” refers to structured data representing purchased items in a canonical form, including at least a standardized item name, a numerical quantity, and an associated unit, and optionally an item category.

The term “item name” refers to a textual identifier of a product or ingredient, which may be normalized to a canonical label to reduce variation among different descriptions of the same item.

The term “quantity” refers to a numerical value associated with an item name that indicates an amount, count, or volume of the item.

The term “unit” refers to a representation of a measurement unit associated with a quantity of an item, such as a weight unit, a volume unit, a count unit, or a package unit.

The term “inventory management information” refers to data representing the current or past stock of items associated with a user or household, including normalized item information, remaining quantities, acquisition dates, and optionally expiration dates and source transaction identifiers.

The term “usage history information” refers to data representing historical consumption or use of items by a user or household, including records of when and how much of an item was used and, optionally, which cooking procedure or event caused the consumption.

The term “cooking procedure information” refers to structured data representing at least one recipe or cooking process, including a title or dish name, a list of required ingredients with quantities and units, and one or more ordered steps describing operations to prepare the dish.

The term “user terminal” refers to an electronic device operated by a user, such as a smartphone, tablet, or personal computer, that is configured to communicate with a server, present information to the user, and receive user input.

The term “notification information” refers to data that is prepared for presentation to a user via a user terminal and that indicates at least one event, condition, or recommendation, including but not limited to predicted item shortages, inventory status, or suggested actions.

The term “expenditure category information” refers to classification data that associates transaction information or item information with one or more expense categories, such as food, utilities, or entertainment, for use in household management and aggregation.

The term “aggregation result” refers to data that is computed by aggregating household management information or expenditure category information according to at least one criterion, such as a time period, category, or item, and that represents summarized values, for example totals or averages.

The term “expiration date” refers to date information associated with an item that indicates a recommended or required latest date for consumption or use of the item.

The term “remaining amount” refers to a value representing a current estimated quantity of an item in inventory, which may be updated based on purchases and usage history.

The term “threshold” refers to a predetermined or dynamically determined reference value used to judge a condition, such as whether a remaining amount of an item is considered low.

The term “external information processing apparatus” refers to a computer system that is separate from the server and that provides at least one service, such as a delivery service or payment service, via a communication network.

The term “delivery service” refers to a service that arranges preparation and transportation of goods or prepared food items to a specified destination for a user.

The term “order information” refers to structured data transmitted from the server to an external information processing apparatus, describing a request for goods or services, and including at least item identifiers, quantities, user-related delivery information, and optional payment-related information.

In one embodiment, a server cooperates with a terminal operated by a user to implement the claimed system. The server is implemented as an information processing apparatus that includes at least one central processing unit (CPU), a main memory, a non-volatile storage device, a network interface, and, optionally, a graphics processing unit (GPU) for accelerating neural network inference. The terminal is implemented as a portable electronic device, such as a smartphone or tablet, that includes an imaging device, a CPU, a memory, local storage, and a wireless communication interface. The server and the terminal communicate via a communication network, such as the Internet, using a standard transport protocol.

The terminal executes an application program that provides a user interface for capturing transaction evidence documents, managing household information, and displaying cooking procedure information. The terminal uses an operating system camera interface, such as a mobile operating system camera framework, to control the imaging device. The imaging device captures image data of a transaction evidence document, such as a receipt or invoice, and stores the image data in a local storage area of the terminal. The terminal then transmits the image data to the server as digital image data over a secure communication channel.

The server executes server-side application software comprising modular components, including an image processing module, a character recognition module, an item normalization module, an inventory management module, a household management module, a generative AI interface module, a shortage prediction module, and an external service integration module. The server stores data in a database management system, such as a relational database, using specific tables or collections for transaction information, normalized item records, inventory records, usage history records, household expenditure records, and generated cooking procedure records. The server maintains defined data schemas, for example, tables having fields such as user identifier, receipt identifier, item identifier, normalized item name, quantity, unit, purchase date, expiration date, category, and usage history attributes.

The server uses the image processing module, implemented for example with an image processing library such as a general-purpose computer vision library, to pre-process the receipt image. The server converts the color image to grayscale, applies noise reduction filters, performs contrast enhancement, and optionally executes geometric correction such as deskewing and perspective transformation. The server thereby generates a pre-processed image that improves the reliability of subsequent character recognition.

The server uses the character recognition module, implemented for example with an optical character recognition engine, to convert the pre-processed image into character string data.

The server configures the OCR engine with a character set corresponding to expected languages and digits, and optionally applies layout analysis to detect text regions. The OCR engine outputs character strings, line by line, including item descriptions, prices, quantities, tax lines, and totals. The server stores the raw OCR result in a database field associated with the receipt identifier.

The server performs rule-based post-processing on the character string data. The server removes non-printable characters, normalizes whitespace, merges hyphenated words, and applies regular expressions to detect numeric patterns, such as prices and quantities. The server also uses a lexicon of known mis-recognitions and corrections (for example, mapping typical OCR errors to correct characters) to reduce recognition noise. Through this post-processing, the server produces structured lines that each contain at least one item-like segment.

The server uses the item normalization module to integrate the OCR-derived text with a generative AI model. The server constructs a prompt sentence that concisely encodes the extraction task and includes the OCR text. For example, the server generates a prompt sentence such as:

“The following text is OCR output from a grocery receipt. Extract the purchased items and for each item provide a normalized item name, a numeric quantity, and a unit. Ignore totals and taxes. Output the result in a clear, line-by-line textual list.
OCR text:
Tomato 3
Mozzarella Cheese 200 G
Basil 1 pack
Total 850 yen.”

The server sends this prompt sentence as plain text to a generative AI model through the generative AI interface module. The generative AI model is implemented, for example, as a transformer-based neural network, trained on a large corpus of natural language and structured text. The model comprises a plurality of attention layers, feedforward layers, and embedding layers, and is parameterized by a large number of weight parameters. During inference, the model processes the prompt sentence token by token and outputs a sequence of tokens that represent normalized items, such as:
“Tomato, quantity: 3, unit: pieces
Mozzarella cheese, quantity: 200, unit: grams
Basil, quantity: 1, unit: pack”

The server parses this textual output using simple pattern matching rules and converts it into normalized item information with defined fields: item_name (canonical text label), quantity (floating-point or integer value), and unit (enumerated unit type). The server thereby transforms unstructured OCR output into machine-usable structured records in a single pass, without relying solely on rigid templates. Because the generative AI model has been trained to generalize from diverse text patterns, the server can accommodate a wide variety of receipt layouts and item descriptions without exhaustive manual rule definition.

The server further uses the generative AI model to classify items into expenditure categories.

The server constructs another prompt sentence, for example:

“Classify each of the following items into a spending category such as ‘food’, ‘household goods’, or ‘other’. Provide one category for each item:
Tomato
Mozzarella cheese
Basil.”

The generative AI model outputs category labels, which the server associates with the normalized items as expenditure category information. The server records this expenditure category information in the household management tables and uses it for efficient aggregation queries, such as computing sums per category per month.

The server maintains inventory management information by aggregating normalized item information per user. For each item, the server stores a remaining amount field, a unit, a purchase date field, and optionally an expiration date field. The server updates the remaining amount when the user indicates that a recipe has been cooked or when an inferred usage event occurs. The server thereby maintains a continuously updated and structured representation of the user's inventory.

The server uses the generative AI model also for generating cooking procedure information.

The server prepares a prompt sentence listing the available inventory items and optional constraints such as serving size or dietary preferences. For example, the server constructs a prompt sentence such as:

“Using the following ingredients that the user currently has in inventory, propose three recipes. For each recipe, describe a title, a list of ingredients with quantities, and numbered cooking steps. Use mostly these ingredients and suggest minimal additional ingredients if necessary.
Ingredients: tomatoes, mozzarella cheese, basil, olive oil, salt, pepper.
Assume 2 servings.”

The generative AI model outputs natural-language text that contains the requested recipes. The server parses the recipes, using pattern recognition on titles, ingredient lists, and numbered steps, and stores the resulting cooking procedure information in a recipe table. The server then provides the cooking procedure information to the user terminal for display. The server also generates leftover-oriented recipes by selecting items with small remaining amounts or with approaching expiration dates from the inventory management information. The server constructs a prompt sentence such as:

“Using as many as possible of these leftover ingredients, propose two recipes that minimize food waste. Clearly indicate ingredients, quantities, and step-by-step instructions. Leftover ingredients: 2 tomatoes, 100 g mozzarella cheese, half a bunch of basil, 50 g bacon.” The generative AI model outputs recipes that prioritize these leftovers. The server thereby helps reduce waste and, at the same time, reduces the number of computation cycles required for manual rule-based optimization, since the generative AI model directly outputs constrained combinations according to the prompt sentence.

The server runs a shortage prediction module that operates on inventory management information and usage history information. The server records for each recipe cooking event which items are consumed and by what amounts. The server then computes average consumption rates per item over configurable time windows. The server compares the remaining amount of each item with the estimated consumption rate to estimate an exhaustion date. If the remaining amount is predicted to fall below a threshold within a predetermined time window, the server generates notification information, such as “Tomatoes are likely to run out in 2 days.” The server sends such notification information to the user terminal through a push notification service or in-application messages. The use of structured inventory data, normalized by the generative AI model, reduces the need for heavy, repeated parsing, and allows the server to execute efficient queries that join inventory tables with usage history using indexed fields.

The server integrates with external information processing apparatuses that provide a delivery service. When the user selects a recipe and chooses to order prepared food, the server maps the dish title and main ingredients to corresponding menu items of available restaurants or vendors. The server maintains mapping tables or uses an additional prompt sentence to ask the generative AI model for a candidate standard dish name that can be matched with the external service catalog. The server generates order information that includes selected dish identifiers, quantities, delivery address, and optional payment token data. The server sends the order information to the external information processing apparatus using a defined application programming interface. The external service returns order confirmation and status updates, which the server relays to the terminal.

The server employs a generative AI model architecture that enables technical improvements beyond human manual processing. The model is implemented as a deep neural network that includes multiple transformer blocks, each block comprising multi-head self-attention mechanisms and position-wise feedforward networks. The server stores learned weight parameters in a model file and loads them into memory for inference. During training, which is optionally performed on a separate training system, the model is trained on a large set of tokenized text sequences using a supervised or self-supervised objective. For example, the model can be trained with a next-token prediction loss or a masked-language modeling loss. A loss function such as cross-entropy is computed between predicted token distributions and target tokens. The training process updates weights by gradient-based optimization, such as stochastic gradient descent with adaptive learning rate methods.

The server fine-tunes or prompts the generative AI model to specialize it in receipt parsing and recipe generation domains. The server or a training subsystem may augment the training data with synthetic receipt text, annotated normalized items, and synthetic recipes. Data augmentation may include adding noise, varying numeric formats, and simulating OCR errors, such that the model learns to robustly interpret noisy input. As a result, when the server uses the generative AI model in production, the model is able to convert irregular and noisy text into consistent structured item information with fewer parsing steps. This reduces the frequency of fallback manual rules, shortens the overall processing pipeline, and improves accuracy compared to purely rule-based approaches.

The server defines internal data structures that align with the model outputs. For example, the server uses a normalized_item table with fields such as (normalized_item_id, user_id, receipt_id, normalized_name, quantity_value, quantity_unit, category_code). The server also uses an inventory table with fields such as (inventory_id, normalized_item_id, remaining_amount, remaining_unit, purchase_date, expiration_date). By designing the schema around normalized item information, the server can directly apply standard database indexing strategies, such as indexing on normalized_name and category_code, which enhances query performance for inventory searches, shortage detection, and category-based aggregations.

The server's architecture thereby yields specific technical effects. First, the server reduces the amount of duplicated data processing by performing OCR and generative normalization only once per receipt and reusing the normalized item records in multiple downstream modules (inventory, household expenditure, recipes, and ordering). Second, the server reduces network traffic and load on the generative AI model by carefully constructing prompt sentences that include only the necessary character string data and task instructions, instead of sending complete raw images or redundant context. Third, the server improves accuracy and stability of item recognition by combining deterministic image processing and OCR with learned generative normalization, which is tolerant to formatting variations. Fourth, by using unified normalized data structures, the server reduces the number of expensive text-based queries and ad hoc joins, improving the speed of inventory and expenditure aggregations. The terminal, as another part of the system, performs specific technical operations. The terminal controls the imaging device via a hardware abstraction interface, configures resolution and exposure when capturing receipts, and encodes the captured image into a compressed format. The terminal manages local caching of receipt images and server responses to reduce unnecessary retransmissions. The terminal displays cooking procedure information, inventory lists, and expenditure summaries with user interface components that allow efficient navigation and minimal bandwidth usage. For example, the terminal displays only summary information at a list level and fetches detailed recipe steps or historical charts on demand, which reduces communication load between the terminal and the server.

The user interacts with the system by capturing transaction evidence documents with the terminal, reviewing suggested recipes, confirming cooking events, and optionally initiating delivery orders. From the user's perspective, the system automates complex recognition and planning tasks. From a technical standpoint, the system restructures these tasks into specific modules and data flows that improve computational efficiency and accuracy within the server and terminal.

Alternative embodiments can modify or extend various components while still operating within the scope of the claims. In one variation, the server implements the generative AI model locally, using a reduced-size transformer model executed on a GPU or specialized accelerator, instead of accessing a remote AI service. In another variation, the server combines outputs from a rule-based parser and the generative AI model, using a ranking or confidence score to choose the best normalized item information. In yet another embodiment, the server applies additional machine learning models, such as gradient-boosted trees, to refine shortage prediction using item-level features such as seasonality, user behavior patterns, and historical wastage rates.

In each embodiment, the server, the terminal, and the user cooperate in a way that is tightly coupled to the technical structure of the computer system and its data processing pipeline. The server does not merely automate human reading of receipts and manual recipe planning, but instead introduces a new layered architecture that combines deterministic image processing, OCR, transformer-based generative modeling, and optimized data schema design. As a result, the system improves computer functioning by reducing processing steps, improving recognition accuracy, compressing the transformation of unstructured images into structured inventory data, and enabling scalable, low-latency computation for notifications and content generation.

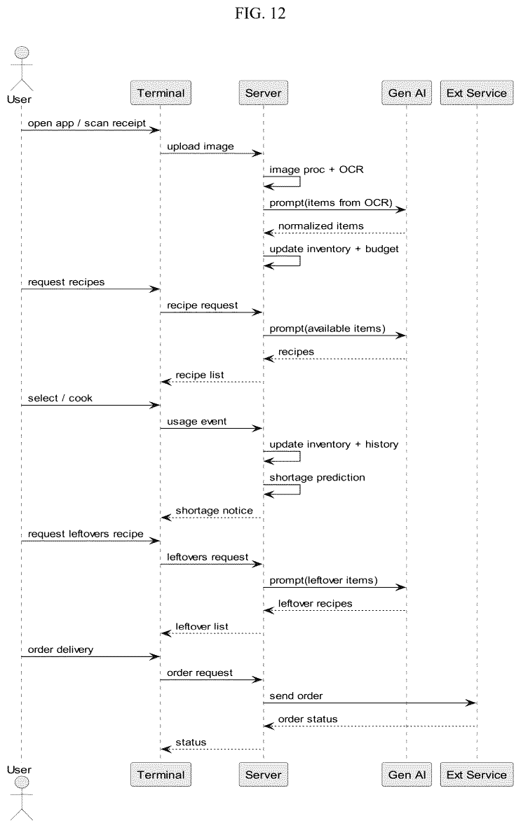

The following describes the processing flow using FIG. 12.

### Step 1

The user launches an application on the terminal and selects a function for capturing a transaction evidence document.

The terminal, as input, receives a user command indicating that a receipt or other transaction evidence document will be captured.

The terminal activates an imaging device via a camera interface of the operating system, displays a live preview, and waits for the user to trigger image capture.

The user positions the transaction evidence document in front of the imaging device and initiates capture through a user interface control.

The terminal, as output, generates image data (for example, a compressed image file) representing the captured document and stores a reference to the image data in local storage.

### Step 2

The terminal, as input, reads the stored image data and associated metadata, such as capture time and user identifier.

The terminal establishes a network connection to the server over a secure communication channel and prepares an upload request containing the image data and metadata.

The terminal transmits the upload request to the server.

The server, as output of this step, receives the image data and metadata and stores the image file in a storage area (for example, a file system or object store) while assigning a unique receipt identifier to the transaction evidence document.

### Step 3

The server, as input, retrieves the stored image data associated with the receipt identifier.

The server applies image processing operations, including grayscale conversion, noise reduction, contrast enhancement, and geometric correction, to the image data to improve legibility of characters.

The server then applies character recognition to the processed image to convert visual character patterns into character string data.

The server, as output, generates raw OCR text that includes lines corresponding to item descriptions, quantities, prices, totals, and other receipt content, and stores the raw OCR text in a database linked to the receipt identifier.

### Step 4

The server, as input, reads the raw OCR text for the receipt and performs rule-based post-processing on the character string data.

The server removes spurious symbols, normalizes whitespace, merges split lines when needed, and uses pattern matching to separate likely item lines from total or header lines.

The server aggregates these cleaned lines into a structured list that associates each candidate item line with its position in the receipt.

The server, as output, produces a preprocessed text representation suitable for input to a generative AI model and stores this representation as intermediate structured text.

### Step 5

The server, as input, takes the preprocessed text representation and constructs a prompt sentence for a generative AI model.

The server embeds the candidate item lines into an instruction text that specifies the extraction task, such as:

“The following text is OCR output from a receipt. Extract each purchased item with a normalized item name, numeric quantity, and unit. Ignore total amounts and taxes. OCR text: . . . ”.

The server transmits this prompt sentence to the generative AI model interface over a network.

The generative AI model, using a transformer-based neural network, processes the prompt sentence and produces textual output describing normalized items.

The server, as output, receives this textual output, which lists items with normalized names, quantities, and units.

### Step 6

The server, as input, parses the textual output from the generative AI model that describes items and their attributes.

The server applies parsing rules and regular expressions to identify segments corresponding to item names, quantities, and units.

The server converts the parsed attributes into normalized item information records, including a canonical item name, a numeric quantity value, and a standardized unit code.

The server, as output, stores these normalized item information records in a normalized item table associated with the user and receipt identifier.

### Step 7

The server, as input, reads the normalized item information records and the corresponding monetary amounts derived from OCR or transaction data.

The server constructs a further prompt sentence instructing the generative AI model to assign expenditure categories to the normalized item names, for example:

“Assign each of the following items to a spending category such as ‘food’, ‘household goods’, or ‘other’. Items: . . . ”.

The server sends the prompt sentence and the list of item names to the generative AI model and receives categorized item descriptions in response.

The server, as output, attaches expenditure category information to each normalized item record and records the categorized data as part of household management information.

### Step 8

The server, as input, takes the normalized item information and updates inventory management information for the user.

The server queries an inventory table to determine whether each normalized item already exists in the user's inventory.

The server increments remaining amounts of existing inventory entries or creates new inventory entries with fields such as remaining amount, unit, purchase date, and optional expiration date.

The server, as output, maintains an updated inventory data structure that reflects the current stock of items for the user.

### Step 9

The user, via the terminal, requests recipe suggestions based on current inventory.

The terminal, as input, receives the user request and transmits a recipe request to the server, including optional constraints such as desired servings or dietary preferences.

The server reads the inventory management information and selects items that are currently available and valid (for example, not expired).

The server constructs a prompt sentence that lists the selected ingredients and specifies the recipe generation task, such as:

“Using the following ingredients that the user has in inventory, propose several recipes. For each recipe, provide a title, a list of ingredients with quantities, and numbered cooking steps. Ingredients: . . . ”.

The server sends this prompt sentence to the generative AI model and receives natural-language descriptions of recipes as output.

### Step 10

The server, as input, parses the recipe descriptions received from the generative AI model.

The server identifies titles, ingredient lists, and numbered steps by detecting specific textual patterns, such as line prefixes or numbering formats.

The server converts this parsed information into structured cooking procedure records, including dish name, ingredients with quantities and units, and ordered procedure steps.

The server, as output, stores the structured recipes in a recipe table and prepares response data for the terminal containing summaries and detailed instructions.

### Step 11

The terminal, as input, receives recipe response data from the server.

The terminal renders lists of recipes in a graphical user interface, displaying key information such as titles, estimated preparation times if provided, and brief descriptions.

The user selects a recipe to view details.

The terminal, as output, displays the full cooking procedure, including the list of ingredients and numbered steps, and marks which ingredients are already in inventory and which are missing, based on inventory indication flags received from the server.

### Step 12

The user, via the terminal, indicates that a particular recipe has been cooked.

The terminal, as input, captures this user action and sends a usage event to the server that includes the recipe identifier and the actual number of servings prepared.

The server retrieves the required ingredients and their quantities from the recipe record and scales the quantities according to the number of servings.

The server, as output, updates the inventory management information by subtracting the used quantities from the remaining amounts of the corresponding inventory items and records a usage history entry describing the consumption event.

### Step 13

The server, as input, periodically reads inventory management information and usage history information for each user.

The server computes an average consumption rate per item by dividing total consumed quantity by the time interval over which consumption occurred.

The server estimates an exhaustion time for each item by dividing the current remaining amount by the consumption rate and compares this estimate with a predetermined time threshold.

The server, as output, identifies items that are predicted to become insufficient within the threshold period and generates notification information describing the predicted shortage for each item.

### Step 14

The server, as input, processes the list of predicted insufficient items and constructs notification messages tailored for the user terminal.

The server aggregates items by urgency and optionally by category, and formats human-readable notification texts.

The server transmits these notification messages to the terminal using a push notification service or an application-level messaging channel.

The terminal, as output, presents visual alerts or messages to the user, indicating, for example, that a particular item is likely to run out within a certain number of days.

### Step 15

The user, via the terminal, selects a function for using leftover ingredients.

The terminal, as input, sends a leftover-recipe request to the server.

The server reads the inventory management information and extracts items that have remaining amounts below a specified threshold or have expiration dates approaching within a defined time window.

The server constructs a prompt sentence enumerating these leftover items and instructing the generative AI model to generate recipes that prioritize their use, such as:

“Using as many as possible of the following leftover ingredients, propose recipes that minimize food waste and provide detailed step-by-step instructions. Leftover ingredients: . . . ”.

The server, as output, receives leftover-oriented recipes from the generative AI model, structures them similarly to other recipes, and sends them to the terminal for display.

### Step 16

The user, via the terminal, initiates an order for prepared food based on a selected recipe.

The terminal, as input, sends an order preparation request to the server with the recipe identifier and user delivery preferences.

The server maps the recipe title and main ingredients to a standardized dish name or directly to menu items of an external delivery service.

The server generates order information, including selected items, quantities, user address, and payment-related data, and sends this order information to an external information processing apparatus via a predefined interface.

The external apparatus returns order confirmation and status information.

The server, as output, updates an order history record and transmits status updates to the terminal, which presents order progress to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented household management systems that handle purchase records and recipe suggestions typically treat receipt data, inventory data, and recipe data as loosely coupled information sources. In many implementations, an image of a receipt is stored separately from structured purchase data, and any recipe suggestion module operates on manually entered ingredient lists rather than on transaction data that is automatically acquired and normalized from actual receipts. As a result, the underlying computing system fails to exploit transaction images as a reliable, machine-usable source for dynamic inventory tracking and automated procedure generation.

Further, in conventional systems, optical character recognition processing and natural language generation are not orchestrated in a unified workflow. Receipt images may be processed with basic optical character recognition to extract text, but the extracted text is not consistently transformed into standardized, hierarchically managed inventory records suitable for subsequent machine analysis. This leads to inconsistent item naming, incompatible units, and fragmented inventory states, which in turn degrade the accuracy of automated computations such as inventory updates or shortage predictions. The computing system therefore cannot maintain an internally coherent representation of user inventory over time. Moreover, known recipe recommendation engines generally rely on static, pre-authored content or simple rule-based selection, and do not leverage generative artificial intelligence models that are driven by programmatically constructed prompt sentences derived from structured transaction and inventory data. Computers in such systems are used merely as passive repositories or display devices, and the generation of recipes or other procedure information remains largely decoupled from the system's core data processing pipeline. This results in limited adaptability of suggested procedures to the user's real-time inventory state and usage history, and forces users to perform considerable manual operations to bridge gaps between transaction records, inventory, and recipe content.

In addition, conventional systems that attempt to notify users of low-stock items often rely on simplistic threshold checks on static inventory quantities, without integrating past consumption histories, procedure utilization histories, or user responses to previous notifications. The notification logic therefore remains coarse and insensitive to user behavior patterns, producing either excessive or untimely notifications. This not only reduces the practical utility of the system but also fails to improve computer-based scheduling and decision logic for notification delivery.

Accordingly, there is a need for a computer-implemented technique that improves the operation of a server and its associated data structures by: (i) tightly integrating receipt image acquisition, character extraction, and standardized item normalization; (ii) maintaining a coherent, hierarchically managed inventory representation derived from real transaction data; (iii) automatically generating prompt sentences that condition a generative artificial intelligence model based on current inventory and leftover data; and (iv) dynamically managing inventory updates and shortage notifications based on computed consumption tendencies and user behavior, thereby enhancing the server's capability to automatically generate and deliver procedure information adapted to the user's actual situation. Such improvements would not merely automate a manual business practice but would improve the functioning of the underlying computer system by providing more accurate data processing, more efficient use of storage and models, and more intelligent control over communication with user terminals.

The specific processing by the specific processing unit 290 of the data processing device 12 in Example 2 is realized by the following means.

The present invention provides a server comprising a processor and a memory storing instructions which, when executed by the processor, cause the processor to acquire and record information relating to economic activities of a user, to extract character information from an image of a document medium and generate, on the basis of the extracted character information, attribute information and quantity information of purchased target objects, to update, on the basis of the attribute information and the quantity information of the target objects, inventory information for each of the target objects that is stored in an information storage unit, to generate a prompt sentence that is configured to preferentially utilize the inventory information, on the basis of the inventory information and information regarding remaining target objects that is input by the user, to input the prompt sentence and the attribute information and the quantity information of the target objects into a generative artificial intelligence model and instruct the generative artificial intelligence model to generate procedure information using the target objects, to acquire the procedure information output from the generative artificial intelligence model, to record the prompt sentence and the procedure information in association with each other in the information storage unit and provide the procedure information to a user terminal, to update the inventory information on the basis of the inventory information and usage amounts of the target objects included in the procedure information, to analyze consumption tendencies of the target objects on the basis of the inventory information and past usage history of the user and extract shortage prediction target objects that satisfy a predetermined threshold, and to generate notification information regarding the shortage prediction target objects and transmit the notification information to the user terminal. This enables an improvement in computer functionality by allowing the server to automatically transform unstructured receipt images into standardized, hierarchically managed inventory records, to construct and supply optimized prompt sentences to a generative artificial intelligence model for context-aware procedure generation, and to intelligently update inventory and control notification timing based on computed consumption tendencies and user behavior, thereby providing more accurate, efficient, and adaptive processing and communication than conventional systems.

The term “economic activities of a user” refers to transactions or operations performed by the user that involve acquisition, use, or payment for goods or services, including but not limited to purchases recorded by receipts, invoices, or electronic payment logs.

The term “document medium” refers to a physical or electronic carrier that represents information in a human-readable form, such as a paper receipt, printed invoice, or an electronic receipt image displayed on a screen.

The term “image of a document medium” refers to digital image data obtained by capturing the document medium using an image acquisition device, such as a camera or scanner, and representing the visual content of the document in a pixel-based format.

The term “character information” refers to alphanumeric symbols, symbols, or other textual elements that are detectable within the image of the document medium and that can be recognized and converted into machine-readable text data.

The term “attribute information of purchased target objects” refers to descriptive data associated with items acquired in a transaction, including but not limited to item names, categories, product types, or other identifying characteristics that distinguish one item from another.

The term “quantity information of purchased target objects” refers to numerical or unit-based data that indicates an amount of each target object acquired in a transaction, such as counts, weights, volumes, or package units.

The term “target object” refers to an item, good, or consumable that is purchased, stored, or used by the user and for which inventory information is to be managed by the system.

The term “inventory information” refers to structured data indicating, for each target object, a current stock state, including at least a quantity, and optionally additional attributes such as storage location, expiration-related data, or category information.

The term “information storage unit” refers to a hardware or software component, such as a memory or database system, that is configured to store, update, and retrieve data including inventory information, prompt sentences, procedure information, usage histories, and notification records.

The term “remaining target objects” refers to target objects that continue to exist in the user's possession after one or more uses, including leftovers reported by the user or inferred from discrepancies between purchased and consumed quantities.

The term “prompt sentence” refers to a text sequence or set of text instructions generated by the system, which is provided as input to a generative artificial intelligence model to condition or control the content, style, or structure of an output generated by the model.

The term “generative artificial intelligence model” refers to a computational model, such as a machine-learned model, that is configured to generate new data, including text-based procedure information, based on input data such as prompt sentences and associated structured information.

The term “procedure information” refers to information describing a sequence of operations to be performed using one or more target objects, including but not limited to step-by-step instructions for preparation, processing, or consumption.

The term “user terminal” refers to an electronic device operated by the user, such as a smartphone, tablet, or personal computer, that is capable of communicating with the server to send and receive data including procedure information and notification information.

The term “usage amount of target objects” refers to a quantity of a target object that is determined, on the basis of procedure information or user actions, to have been consumed or utilized during execution of a procedure.

The term “past usage history of the user” refers to data indicating past interactions or operations performed by the user with respect to target objects and procedure information, including but not limited to previous procedures selected, executed, or completed, and associated consumption records.

The term “consumption tendencies” refers to patterns or statistical characteristics of how target objects are consumed over time by the user, derived from inventory changes, usage amounts, and past usage history.

The term “shortage prediction target objects” refers to target objects that are identified, based on the consumption tendencies and current inventory information, as likely to reach or fall below a predetermined threshold within a specified future period.

The term “predetermined threshold” refers to a defined criterion or value, such as a minimum stock quantity or a remaining-usage-duration value, used by the system to determine whether a target object should be classified as a shortage prediction target object.

The term “notification information” refers to message content or data generated by the system for presentation to the user, indicating at least a state or prediction related to target objects, such as impending shortage, and optionally including recommended actions.

In one embodiment, a server cooperates with a terminal operated by a user in order to perform end-to-end processing from acquisition of transaction information to generation and delivery of procedure information derived from a generative AI model. The server includes at least one processor, a main memory, a non-volatile storage device, and a network interface. The terminal includes at least one processor, a memory, a display, an input device such as a touch panel, an image acquisition device such as a camera, and a wireless or wired communication interface.

The server stores, in the non-volatile storage device, a program comprising a plurality of software modules. The server executes these modules using the processor and the main memory. The server, in one example, executes a web application stack implemented on a general-purpose operating system. The web application stack may comprise an application framework (for example, a framework of a type comparable to a Python-based or JavaScript-based web framework), a relational database management system (for example, a system of a type comparable to a structured query database engine), an object storage interface, an optical character recognition (OCR) library (for example, an OCR engine of a type comparable to a common open-source OCR engine or a cloud-based OCR service), and a client library for accessing an external generative AI model via a network-based application programming interface.

The terminal executes an application that allows the user to capture an image of a document medium, such as a paper receipt. The terminal activates the camera hardware through an operating-system-level camera application programming interface and acquires a digital image of the document medium. The terminal encodes the captured image into a compressed pixel data format such as JPEG or PNG. The terminal temporarily stores the encoded image in a local file system or application sandbox.

The terminal transmits the encoded image and associated metadata to the server over a network using a secure communication protocol. The terminal embeds a user identifier and context information in a request message and sends the request to a predetermined application programming interface endpoint exposed by the server. The server receives the request through the network interface and stores the raw image data and metadata in the non-volatile storage device or an external object storage system, while registering a transaction record in the database.

The server performs character extraction by inputting the stored image data into the OCR library. The server configures the OCR library with parameters such as language model type, character set, and page segmentation mode, and then executes the OCR algorithm. The OCR library, in one example, performs connected-component analysis on the pixel grid, segments the image into text lines and character regions, and applies a neural network or statistical classifier to recognize character codes. The server receives the recognized text as a sequence of character codes with associated layout information (for example, line positions and bounding boxes) and stores this text as character information in the database. The server performs text parsing by executing a dedicated parsing module. The server uses regular expressions, rule-based tokenization, and string normalization to identify candidate item lines in the character information. The server, for example, identifies substrings matching patterns of “text field, whitespace, numeric quantity, whitespace, numeric price.”

The server normalizes alphabetic characters to a canonical case, removes extraneous symbols, and applies a mapping table that converts various synonymous item names into a standardized attribute name. The server converts quantities into standardized unit forms by referencing a unit-conversion table that associates different unit abbreviations with canonical unit types and conversion coefficients.

The server writes, into the database, a set of normalized item records comprising attribute information and quantity information. The server uses a relational schema that associates each item record with a transaction record and a user identifier. The server maintains an inventory table where each row represents a target object and includes standardized name information, standardized unit information, current quantity, category, and optional expiration-related data. The server updates the inventory table by incrementing the quantity field for each standardized item, and records the update in an inventory history table.

The server, in this manner, improves data management by transforming unstructured image data into a normalized, hierarchically organized inventory data structure. The server, by using standardized names and units, prevents fragmentation of logically identical items under different labels, which reduces redundancy in the database and lowers the computational cost of aggregation queries. This normalization also improves accuracy and speed of later calculations such as consumption rate estimation and shortage prediction, because the server can perform vectorized or indexed operations over unified item keys rather than scanning heterogeneous text fields.

The server generates a prompt sentence for a generative AI model. The server composes the prompt sentence by retrieving current inventory information and user-reported remaining target objects from the database. The server, for example, generates a natural-language description of available ingredients by enumerating attribute information and quantity information in a human-readable form. The server then embeds this description into a higher-level instruction text that specifies the role of the generative AI model, the desired output structure, and constraints such as preparation time or number of suggestions.

The server, in one specific example, generates a prompt sentence such as:
“You are a cooking assistant. The user has the following ingredients: 3 tomatoes, 1 onion, 200 g of chicken breast, and 100 g of cheese. Propose two easy dinner recipes that can be prepared in under 30 minutes. Provide ingredient lists and step-by-step cooking procedures.”

In another example, when the user explicitly reports leftovers, the server generates a prompt sentence such as:
“You are a cooking assistant. The user has leftover ingredients: 3 tomatoes, 1 half onion, and 50 g of cheese. Propose three recipes that primarily use these leftovers and minimize food waste. Provide clear, step-by-step cooking procedures and simple ingredient lists.”

The server uses a generative AI model that comprises a neural network of the transformer architecture type. The generative AI model includes an input embedding layer, a plurality of self-attention layers, feed-forward sublayers, and an output layer that predicts tokens of natural-language text. The model parameters, including attention weights and feed-forward weights, are learned in advance by supervised learning or self-supervised learning on a large corpus of text data. The server accesses the generative AI model via a network-based interface provided by a model hosting service.

The server configures the generative AI model with generation parameters such as maximum output token length, sampling temperature, and top-k or nucleus sampling thresholds. The server sends the prompt sentence and, optionally, a structured representation of the inventory data to the model. The generative AI model processes the prompt sentence by converting each token into an embedding vector, iteratively propagating the vectors through the attention layers, and applying a softmax function in the output layer to generate a probability distribution over possible next tokens. The model then samples or selects each next token according to the configured decoding strategy, constructing a sequence that represents procedure information, such as recipe steps.

The server acquires the generated procedure information and parses it to identify ingredient lists and step-by-step actions. The server may enforce a constrained output format by inserting explicit markers in the prompt sentence (for example, “List the ingredients under the heading ‘Ingredients:’ and list each step under the heading ‘Steps:’”). The server splits the generated text at these markers and stores the structured procedure information in a recipes table in the database, along with the prompt sentence and references to the inventory items. The server updates the inventory information by computing the usage amount of each target object referenced in the procedure information. The server derives the usage amount by parsing the ingredient section of the generated text. The server, for example, detects patterns such as “Tomato: 2 pieces” or “Tomatoes 2” and converts the described quantity into the standardized unit stored in the inventory table. The server subtracts the usage amount from the current inventory quantity, updates the inventory records, and logs the consumption event in the inventory history table.

The server analyzes consumption tendencies by applying statistical computations and forecasting algorithms over the inventory history. The server aggregates consumption events by item and time period, calculating an average daily or weekly consumption rate for each target object. The server, in one embodiment, applies a time-series model such as an exponential smoothing model or a regression model to estimate future consumption patterns. The server compares predicted consumption with current inventory levels to compute an estimated depletion date for each item.

The server selects, as shortage prediction target objects, those items for which the predicted depletion date falls within a predetermined threshold interval. The server generates notification information for each shortage prediction target object. The server formats the notification information as text suitable for presentation on the terminal, for example:
“Cooking oil is likely to run out in about three days. Please consider replenishing it.”

The terminal receives the notification information from the server and displays it to the user via a notification mechanism provided by the operating system or the application. The user interacts with the notification by opening an application screen where the predicted shortages are listed. The user can select items for addition to a shopping list, or can dismiss the notification. The terminal sends the user's response back to the server.

The server records the user's response and the time of interaction in a response history table in the database. The server uses this response history to refine future notification scheduling by identifying patterns in how quickly the user reacts to different notification timings. The server, for example, may adjust the predetermined threshold or shift notification times closer to the estimated depletion date for items where earlier notifications consistently remain unacknowledged. In this way, the server performs an adaptive control of notification timing that is based on quantitative behavioral data rather than static rules.

The server applies machine-learning techniques to refine consumption tendency analysis and notification strategies. The server can, in another embodiment, train a predictive model using feature vectors that include item category, historical consumption rates, day-of-week usage distribution, procedure frequency, and user response latency. The server uses an error function, such as mean squared error between predicted depletion dates and actual depletion events, to evaluate the model, and updates model parameters using gradient-based optimization. This reduces forecast errors over time and thereby reduces unnecessary or late notifications, which improves the efficiency of system-initiated communication.

The server and terminal, by operating in this manner, provide technical improvements over conventional systems. The normalization of data via standardized attribute and unit information enables the server to operate with reduced storage fragmentation and faster indexed lookup for item-based queries. The integrated pipeline from image capture, through OCR and normalization, into generative AI-based procedure generation reduces manual data entry and reduces the probability of human transcription errors. The use of a transformer-based generative AI model, conditioned by programmatically generated prompt sentences that incorporate real-time inventory data, enables the server to generate procedure information that is tightly coupled to the current system state. This coupling reduces redundant steps in generated procedures, such as suggesting unavailable ingredients, which in turn reduces wasted computation on unfeasible recommendations.

The server, by associating each prompt sentence with its corresponding procedure information and inventory state, builds a training dataset that can be used to further refine internal models and heuristics. The server can optimize prompt construction rules to achieve shorter prompt sentences that still yield accurate and structured outputs from the generative AI model, thereby reducing communication load and processing time at the model side. The server, for example, can experimentally compare different prompt templates and select those that minimize output parsing failures and maximize ingredient extraction accuracy.

The server, in another embodiment, uses an internal rule set to post-process the output of the generative AI model. The server applies domain-specific rules such as enforcing consistency between ingredient quantities and inventory quantities, rejecting recipes that require ingredients not present in the inventory unless explicitly permitted by a user setting, and rebalancing recipe steps to match device capabilities or time constraints. These rules are implemented as algorithmic checks and transformations that operate on the structured procedure information, not as human intuition. The use of such machine-enforceable rules provides an additional technical layer that ensures the generated content remains compatible with the system's state and constraints.

The terminal, in another embodiment, executes local pre-processing of document images to reduce the computational burden on the server and to increase OCR accuracy. The terminal can perform contrast enhancement, noise reduction, and perspective correction using image processing algorithms before transmitting images to the server. These algorithms operate on pixel arrays and adjust brightness, contrast, and geometric distortion. By offloading such pre-processing to the terminal, the server can process OCR tasks faster and with higher recognition accuracy, thereby reducing end-to-end latency and improving the quality of downstream data processing.

The user can operate the terminal to explicitly input free-form prompt sentences for the generative AI model. The user, for example, may enter “Suggest three dinner recipes using chicken breast, broccoli, and leftover rice, and make sure the recipes are suitable for a family of four.” The terminal transmits this prompt sentence to the server. The server can augment the user-provided prompt sentence with internal inventory data and system constraints before forwarding it to the generative AI model. This combined use of human input and machine-generated context allows the system to produce outputs that are both user-intended and system-feasible, while maintaining the underlying data integrity and technical constraints.

In yet another embodiment, the server deploys the generative AI model locally rather than accessing an external model hosting service. In such a configuration, the server stores model parameters in the non-volatile storage device and loads them into memory at runtime. The server uses a computation library optimized for matrix operations and parallel processing, and may use hardware acceleration such as graphics processing units or specialized tensor processing units. By executing the generative AI model locally, the server can reduce network latency and increase reliability, while also enabling tighter integration between the model's internal state and the system's inventory and history data structures. In this overall configuration, the server, terminal, and user cooperate to form a system where complex, multi-stage data transformations—including image-based acquisition, normalized database structuring, generative AI-based procedure synthesis, and adaptive notification control—are executed in a determinate and repeatable manner. These processes, by design, improve technical aspects of computer operation, including improved accuracy of OCR-to-inventory mapping, reduced storage redundancy via standardized identifiers, efficient computation of consumption rates using coherent data, and optimized communication between the server and the generative AI model via carefully constructed prompt sentences.

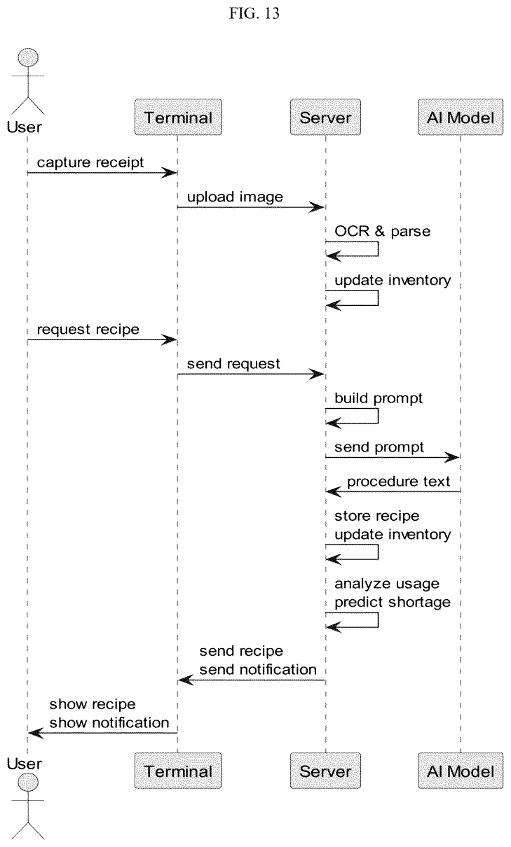

The following describes the processing flow using FIG. 13.

### Step 1

User prepares a document medium such as a receipt and positions it in front of the terminal camera. Terminal receives an instruction from the user to start capture, activates the camera hardware via an operating system camera API, and displays a live preview on the display. The input to this step is the physical document medium and the user's capture command. Terminal captures the document image as pixel data, encodes the pixel data into an image file format such as JPEG or PNG, and stores the file temporarily in local storage. The output of this step is encoded image data of the document medium and associated local metadata such as capture time and provisional file path.

### Step 2

Terminal constructs a transmission request that includes the encoded image data and metadata. The input to this step is the locally stored image file and the user identifier stored in the terminal application. Terminal embeds the user identifier, timestamp, and optionally a transaction category in a structured message, attaches the image file as binary data, and sends the message to the server via a secure network protocol. The output of this step is a network request containing the image data and metadata delivered to the server.

### Step 3

Server receives the network request through a network interface and validates the contained data. The input to this step is the request message including encoded image data and metadata. Server authenticates the user identifier, checks the file type and size, and rejects the request if it does not satisfy predefined constraints. Server stores the image data in persistent storage such as a file system or object storage, and creates a transaction record in a database table with fields for user ID, storage location of the image, and a processing status flag. The output of this step is a stored image reference and a registered transaction record associated with the user.

### Step 4

Server performs optical character recognition on the stored image to extract character information. The input to this step is the stored image reference obtained from the transaction record. Server loads the image file from storage into memory, calls an OCR library with parameters such as language and page segmentation mode, and processes the pixel data to detect character shapes, segment lines, and recognize character codes. Server receives a structured OCR result including recognized strings and their positions, and converts this result into plain text lines representing the content of the document. The output of this step is character information in the form of text data linked to the original transaction record.

### Step 5

Server parses the character information to obtain attribute information and quantity information of purchased target objects. The input to this step is the text representing the recognized content of the document. Server applies tokenization, pattern matching, and normalization rules to identify lines that correspond to individual purchased items. Server splits each identified line into a name segment, a quantity segment, and optionally a price segment, and then converts the name into standardized attribute information using a synonym mapping table. Server converts the quantity into a standardized numerical value and unit by applying a unit conversion table. The output of this step is a collection of normalized item records, each containing standardized attribute information and standardized quantity information.

### Step 6

Server updates inventory information for each target object based on the normalized item records. The input to this step is the collection of normalized item records linked to the transaction. Server queries an inventory table to determine whether each standardized attribute already exists as a managed target object. Server creates a new inventory entry if none exists, or increments the current quantity if an entry exists. Server records each change in an inventory history table with fields for operation type, amount, and timestamp. The output of this step is an updated inventory table that accurately reflects the new stock acquired by the user and a corresponding history log.

### Step 7

User optionally reports remaining target objects and requests procedure generation. The input to this step is the user's interaction with the terminal interface. User selects one or more items from a displayed inventory list or inputs free-form text such as “3 tomatoes left.” Terminal collects the selection or text, associates it with the user identifier, and sends a request to the server indicating a desire to generate procedure information such as recipes. The output of this step is a generation request containing leftover information and a link to the user's inventory.

### Step 8

Server generates a prompt sentence for a generative AI model based on the inventory information and the reported remaining target objects. The input to this step is the inventory table for the user and the leftover information received from the terminal. Server extracts attribute information and quantity information for relevant target objects, formats a natural-language list of available items, and embeds this list into a higher-level instruction text that defines the role of the model and the requested output. For example, Server composes a prompt sentence such as: “You are a cooking assistant. The user has leftover ingredients: 3 tomatoes, 1 half onion, and 50 g of cheese. Propose three recipes that primarily use these leftovers and minimize food waste. Provide clear, step-by-step cooking procedures and simple ingredient lists.” Server stores the generated prompt sentence in a database for traceability. The output of this step is a finalized prompt sentence tailored to the user's current inventory and leftovers.

### Step 9

Server transmits the prompt sentence and associated structured ingredient information to the generative AI model and obtains procedure information. The input to this step is the prompt sentence generated in Step 8 and a structured list of target objects and quantities. Server constructs a model request message that includes the prompt sentence, model parameters such as maximum token length and temperature, and optionally a machine-readable ingredient list. Server sends this message via an application programming interface to the generative AI model. The model processes the input and returns generated text describing procedure information, such as detailed step-by-step cooking instructions and ingredient lists. Server receives the model's response, checks for required sections and content validity, and parses the text into structured fields. The output of this step is structured procedure information associated with the prompt sentence and the user.

### Step 10

Server records the procedure information and associates it with inventory and history data. The input to this step is the structured procedure information and the originating prompt sentence. Server inserts a new record into a recipes table containing titles, ingredient descriptions, steps, and links to the inventory items referenced in the ingredients. Server stores the prompt sentence together with a reference to the recipe record, and optionally associates the recipe with the source transaction that originally provided the items. The output of this step is a persistent record of procedure information that can be reused for later consumption analysis and user presentation.

### Step 11

Server updates inventory information to reflect the usage amounts of target objects in the generated procedure. The input to this step is the ingredient section of the stored procedure information and the current inventory table. Server parses each ingredient line to extract a specific target object name and quantity, then maps the object name to standardized attribute information already in the inventory. Server converts the described quantity into standardized units if necessary and subtracts this usage amount from the corresponding inventory quantity. Server logs each subtraction as a consumption event in the inventory history table. The output of this step is updated inventory information that reflects the expected or actual use of target objects in the generated procedure.

### Step 12

Server analyzes consumption tendencies and predicts shortage prediction target objects. The input to this step is the inventory history table and the current inventory table. Server aggregates historical consumption records per target object, computes average consumption rates for specific time windows, and may apply a forecasting algorithm to estimate future consumption for each target object. Server compares the predicted consumption with the current quantity and calculates a projected depletion time. Server identifies any target objects whose projected depletion time falls within a predetermined threshold interval and classifies them as shortage prediction target objects. The output of this step is a list of target objects predicted to become insufficient within the defined time frame.

### Step 13

Server generates and transmits notification information regarding shortage prediction target objects. The input to this step is the list of shortage prediction target objects produced in Step 12. Server constructs human-readable notification messages that specify which target objects are at risk and an estimated time until depletion, for example “Cooking oil is likely to run out in about three days. Please consider replenishing it.” Server stores each notification message in a notification table with a status indicating unsent or pending. Server then sends the notification messages to the user terminal using a messaging or push notification mechanism. The output of this step is notification information delivered to the terminal and registered in the server's notification log.

### Step 14

Terminal receives procedure information and notification information from the server and presents them to the user. The input to this step is response data from the server containing recipes and notifications. Terminal parses the received data, renders recipe titles, ingredients, and steps on the display, and displays notifications either as in-app messages or system-level alerts. User reviews the presented procedure information and may select a recipe to follow or may respond to a notification by adding items to a shopping list. The output of this step is user interaction events, such as recipe selection or notification acknowledgement, that are sent back to the server for further updating of inventory, usage history, and notification strategies.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems for household management and shopping support generally treat transaction processing, inventory tracking, recipe suggestion, and notification control as separate functions. A typical architecture relies on static rule-based logic and simple optical character recognition to extract receipt data, followed by fixed templates for recipes and reminders. Such systems suffer from several technical problems.

First, existing systems do not integrate image-based transaction extraction, inventory state, historical usage data, and user emotion signals into a unified data model that can be consumed in real time by a generative AI model. As a result, a processor must execute multiple loosely coupled applications and transformation layers, which increases processing overhead, leads to redundant data conversions, and causes latency and inconsistencies between transaction records, inventory databases, and user interfaces.

Second, known systems typically use rigid prompts or hard-coded query patterns when interacting with AI components or analytic engines. These prompts do not adapt to changes in the underlying inventory database, usage history, or user state. This static behavior limits the ability of the processor to generate contextually appropriate outputs, such as cooking procedures or consumption plans, and forces additional post-processing on the client side, thereby increasing network traffic and memory usage at user terminals.

Third, conventional reminder and notification subsystems are generally decoupled from emotion analysis engines. Notifications for low-stock consumables are scheduled using fixed thresholds or simple time-based rules. Such an approach does not consider the user's emotional state when computing notification timing or message content, and thus can lead to notifications being delivered at technically suboptimal times from the system's perspective, for example resulting in poor user engagement, higher dismissal rates, and unnecessary repeated retry transmissions. This, in turn, increases processor load, network congestion, and storage requirements for unacknowledged or retried notifications.

Fourth, existing systems do not leverage generative AI models as a core processing element for both image-derived data interpretation and text generation, driven by dynamically constructed prompt sentences that are automatically synthesized from multiple heterogeneous data sources (transaction data, inventory data, usage history, emotion history). This lack of deep integration between structured data and generative processing prevents the system from offloading complex reasoning and composition tasks to the AI component, thereby reducing the overall efficiency and scalability of the computing architecture.

Accordingly, there is a need for an improved computer-implemented system and server architecture in which a processor: (i) acquires and normalizes transaction and receipt image data, (ii) generates context-sensitive prompt sentences that instruct a generative AI model to perform both image analysis and text generation, (iii) maintains synchronized financial and inventory databases, (iv) predicts depletion of consumables using machine learning or statistical methods, and (v) adjusts notification timing and message content based on user emotion. Such a system should reduce redundant computation, lower network and storage overhead, and provide more accurate and adaptive outputs in a technically efficient manner, thereby improving the operation of the computer system itself rather than merely automating a manual business workflow.

The specific processing by the specific processing unit 290 of the data processing device 12 in Application Example 2 is realized by the following means.

The present invention provides a server comprising a processor configured to acquire and record transaction information of a user, to acquire image data of a receipt or a transaction record from a user terminal, to generate a prompt sentence instructing a generative AI model to perform image recognition processing for extracting transaction content from the image data, and to input the image data and the prompt sentence into the generative AI model; to obtain analysis results from the generative AI model, to identify purchased items based on the analysis results, and to store the purchased items as inventory information and accounting information in one or more storage units; to extract available items based on the inventory information, to generate a prompt sentence that reflects a current emotional state and a usage situation of the user, to input the prompt sentence into the generative AI model, and to thereby generate, from the generative AI model, at least one of a cooking procedure and a consumption plan that uses the available items; to update the inventory information based on the generated cooking procedure or the generated consumption plan and to reflect remaining items in one or more subsequent cooking procedures or consumption plans; to identify, based on a usage history and the inventory information of consumable items, one or more items predicted to become insufficient, to generate notification content regarding the one or more items predicted to become insufficient, and to transmit the notification content to the user terminal; and to acquire at least one of voice information, image information, and text information of the user, to estimate the emotional state of the user by using an emotion analysis engine based on the acquired information, and to adjust at least one of the notification content, a notification timing, and a content of the cooking procedure or the consumption plan in accordance with the emotional state. This enables the server to orchestrate image analysis, structured data management, generative processing, prediction, and emotion-aware notification control within a unified computational framework, thereby reducing redundant processing, improving utilization of storage and network resources, and enhancing the technical performance and adaptability of the computer system as a whole.

The term “transaction information, refers to electronic data representing details of a commercial activity performed by a user, including at least one of a date, a time, a monetary amount, a counterparty identifier, and item-level information related to purchased goods or services.

The term “receipt” refers to a record of a commercial transaction provided to a user, in physical or electronic form, including at least one of a list of purchased items, quantities, prices, tax information, and a total amount.

The term “transaction record” refers to structured or semi-structured data associated with a commercial transaction, including but not limited to a digital receipt, a billing statement, a payment log entry, or a point-of-sale record.

The term “image data” refers to digital data representing a visual capture of an object, such as a receipt or transaction record, including at least one still image or video frame encoded in a predetermined format.

The term “user terminal” refers to an information processing apparatus operated by a user, including at least one of a smartphone, a tablet, a personal computer, or a similar communication device capable of capturing data and communicating with a server.

The term “prompt sentence” refers to a text string or structured linguistic instruction that is generated by a processor and provided as input to a generative AI model to specify a processing task or a desired output format.

The term “generative AI model” refers to an information processing model that receives input data including at least one prompt sentence and generates output data such as interpreted content, structured information, or natural language text based on learned statistical or neural representations.

The term “image recognition processing” refers to computational processing that analyzes image data to detect, extract, or classify visual elements, including at least one of text regions, characters, symbols, objects, or layout structures.

The term “analysis results” refers to data output by a generative AI model or other analytic component, including at least one of recognized text, extracted item attributes, inferred classifications, and generated natural language descriptions.

The term “purchased items” refers to goods or services that are identified as being acquired by a user in a transaction, based on transaction information, receipt data, or analysis results.

The term “inventory information” refers to structured data indicating a current state of possession for one or more items, including at least one of an item identifier, a quantity, a unit, a location, and an expiration date.

The term “accounting information” refers to structured data used for financial management, including at least one of a transaction date, an amount, a category, a payment method, and aggregate financial metrics derived from such data.

The term “storage unit” refers to a logical or physical component capable of storing data, including at least one of a database, a file system, a memory device, or a persistent storage service.

The term “available items” refers to items that are indicated, by inventory information, as being currently present and usable for at least one of consumption, cooking, or other intended use.

The term “cooking procedure” refers to a sequence of instructions describing how to prepare or cook a dish using one or more items as ingredients, including at least one of ingredient lists, quantities, and ordered preparation steps.

The term “consumption plan” refers to information specifying how and when one or more items are to be used, consumed, or depleted over a period of time, including scheduling or prioritization of item usage.

The term “usage situation” refers to contextual information regarding how a user has used or is expected to use items, including at least one of time-of-day, frequency of use, recent consumption events, and user preferences.

The term “usage history” refers to recorded data indicating how items have been used over time, including at least one of timestamps, used quantities, and associated actions or events.

The term “remaining items” refers to items whose quantities, indicated in the inventory information, are greater than zero after at least one consumption event or cooking procedure has been applied.

The term “consumable items” refers to items that are gradually depleted through use and require periodic replenishment, including at least one of foodstuffs, household products, and personal care products.

The term “notification content” refers to information that is formatted for delivery to a user terminal to inform the user of a condition or recommended action, including at least one of a message body, a title, and associated metadata.

The term “voice information” refers to digital data obtained from audio signals produced by a user, including at least one of speech content, prosodic features, and other vocal characteristics.

The term “image information” refers to digital visual data representing at least part of a user or an environment associated with the user, including at least one of facial images and body images.

The term “text information” refers to character-based data associated with a user, including at least one of typed input, transcribed speech, and message content.

The term “emotion analysis engine” refers to a software or hardware component that receives at least one of voice information, image information, and text information and outputs an estimation of an emotional state of a user.

The term “emotional state” refers to information representing a psychological or affective condition of a user, including at least one of joy, stress, anger, fatigue, or neutrality, optionally expressed as labels, scores, or probability values.

The term “notification timing” refers to a point in time or a time window determined by a processor for transmitting notification content to a user terminal based on at least one of item status, prediction results, and emotional state.

The term “optical character recognition processing” refers to processing that analyzes image data containing printed or handwritten characters and outputs corresponding character codes or text strings.

The term “financial management database” refers to a structured data repository used to store and manage accounting information related to user transactions, including metadata associating transactions with categories and time periods.

The term “inventory management database” refers to a structured data repository used to store and manage inventory information for items associated with one or more users.

The term “depletion prediction time” refers to a predicted time or date at which a quantity of a consumable item is expected to reach a predetermined threshold, such as zero or a low-stock level.

The term “machine learning algorithm” refers to a computational method that adjusts internal parameters based on training data in order to perform tasks such as prediction, classification, or regression, including at least one of supervised, unsupervised, and reinforcement learning methods.

The term “statistical processing method” refers to a technique using mathematical statistics to analyze data, including at least one of regression analysis, time-series analysis, and probability distribution fitting.

The term “reminder notification” refers to notification content that is transmitted to a user terminal for the purpose of prompting the user to perform a future action, such as replenishing a consumable item.

The term “message expression” refers to a linguistic style, tone, or phrasing of a notification or message, including at least one of politeness level, emotional nuance, and length.

In the following description of exemplary embodiments, a server, a terminal, and a user cooperate to implement the claimed system. A “server” denotes one or more physical or virtual computing machines, each including at least one processor, memory, non-volatile storage, and network interface. A “terminal” denotes an information processing device operated by the user, such as a smartphone, tablet, or personal computer, including at least a processor, memory, camera, microphone, display, and wireless communication interface. A “user” denotes a person who performs operations using the terminal.

### A. Overall System Configuration

### A.1 Hardware Configuration

The server executes a plurality of software modules on general-purpose computing hardware. The server includes at least one central processing unit (CPU) or graphics processing unit (GPU), a main memory, a non-volatile storage device, and a network interface connected to a packet-switched network such as the Internet.

The terminal includes a mobile operating system, a camera module, a microphone, a display module, and a wireless communication module. The terminal communicates with the server via wireless communication protocols, such as Wi-Fi or a mobile communication standard, using a secure transport protocol such as HTTPS.

### A.2 Software Modules

The server executes, in memory, a receipt analysis module, a transaction management module, an inventory management module, a financial management module, a generative AI interface module, an emotion analysis interface module, a prediction module for consumable depletion, and a notification management module.

The terminal executes a mobile application including a user interface module, a camera acquisition module, a microphone acquisition module, a local cache module, and a push notification handler module.

### B. Data Structures

The server maintains multiple structured data repositories in a storage unit such as a relational database system or a non-relational key-value storage system.

The server stores transaction information in a transaction table. The transaction table contains fields including a user identifier, a transaction identifier, a transaction date, a total amount, a merchant category, and a reference to a receipt image identifier.

The server stores item-level purchase information in an item table. The item table includes fields such as a transaction identifier, an item identifier, a canonical item name, a quantity, a unit, a unit price, and a classification code indicating whether the item is a consumable item or an ingredient.

The server stores inventory information in an inventory table. The inventory table includes a user identifier, an item identifier, a current quantity, a unit, an optional expiration date, and a status flag indicating availability.

The server stores accounting information in a financial management table. The financial management table aggregates transaction-level and item-level information per time period and category for financial analysis.

The server stores usage history in a usage history table. The usage history table links each consumption event of an item with a timestamp, a consumed quantity, and a reference to a generated cooking procedure or consumption plan.

The server stores emotion history in an emotion history table. The emotion history table associates time-stamped emotion states with respective user identifiers and contexts, such as “before meal” or “after work.”

The server stores depletion forecast information in a depletion forecast table. The depletion forecast table includes, for each consumable item and user, a predicted depletion date, a confidence score, and a recommended reminder lead time.

The server stores generated content, such as cooking procedures and reminder messages, in a generated content table. The generated content table contains fields including a content identifier, a content type, a generation time, a reference to input data, and a reference to the underlying prompt sentence.

### C. Generative Ai Model Architecture and Interface

### C.1 Model Structure

The server uses a generative AI model that is implemented as a transformer-based neural network. The generative AI model includes a plurality of self-attention layers, feed-forward layers, and normalization layers arranged in depth. The generative AI model is pre-trained on a large corpus of text data to learn token-level statistical dependencies and is optionally fine-tuned on domain-specific data sets describing cooking procedures, consumption plans, and notification messages.

The generative AI model processes inputs that comprise a prompt sentence token sequence and, optionally, structured auxiliary features that are serialized into text tokens. The model outputs a sequence of tokens that are decoded into human-readable natural language text. The server represents prompt sentences as a sequence of tokens generated by a tokenizer module. The tokenizer converts characters of the prompt sentence into subword units and assigns each unit an index from a vocabulary. The server also encodes inventory features, item quantities, and emotion scores as text tokens embedded into the prompt sentence.

### C.2 Training and Adaptation

The server trains the generative AI model using a loss function that measures the cross-entropy between predicted token distributions and ground-truth next tokens. The server updates model parameters through gradient-based optimization, such as stochastic gradient descent or an adaptive variant. The server optionally applies techniques such as data augmentation, where item names, quantities, and emotion labels are synthetically varied to improve robustness, and regularization, where dropout is applied to attention weights to reduce overfitting.

The server may adapt the model to user behavior by fine-tuning on feedback-labeled data. The server logs, in the generated content table and usage history table, which outputs were accepted, edited, or rejected by the user. The server can use these logs as supervision signals to adjust the model for improved personalization and technical performance.

### C.3 Generative AI Interface

The server exposes the generative AI model through a generative AI interface module that receives a structured request including a prompt sentence, configuration parameters such as a temperature value and a maximum number of output tokens, and a context identifier. The server encodes this request into an intermediate representation, invokes the generative AI model, and receives the tokenized output. The server decodes the tokens into a text string, and parses structured segments such as an ingredient list, ordered steps, or a message body.

Because the server uses a generative AI model capable of processing complex prompt sentences derived from multiple data sources, the server can reduce the number of separate rule-based components necessary for reasoning and composition. This yields an improvement in maintainability and in overall processing efficiency compared to a traditional pipeline of rigid rule engines.

### D. Emotion Analysis Engine and Features

The server uses an emotion analysis engine as an external or internal module. The emotion analysis engine receives, as input, voice information, image information, or text information, and outputs emotion features including discrete labels and continuous scores.

The server can implement a voice-based emotion classifier using a recurrent neural network or a transformer model applied to acoustic features such as Mel-frequency cepstral coefficients, pitch contours, and energy profiles. The server can implement a vision-based emotion classifier using a convolutional neural network applied to face images. The server can implement a text-based emotion classifier using a transformer model operating on the user's typed or transcribed text.

The server collects the emotion features into a fixed-length vector that includes probability scores for emotional categories such as joy, anger, sadness, stress, and neutrality. The server writes these vectors and associated labels into the emotion history table. The server uses the emotion features as input to the generative AI model by encoding the emotion category and intensity into textual tokens appended to the prompt sentence. In addition, the server uses the emotion features as input to the prediction module and notification management module to adjust scheduling and message expression.

### E. Consumable Depletion Prediction Module

The server implements a prediction module for consumable depletion using one or more machine learning algorithms or statistical processing methods. The prediction module uses the usage history table and item table to compute, for each consumable item, representative features such as average inter-purchase interval, average daily consumption rate, standard deviation of consumption intervals, and seasonality indicators.

The server can implement the prediction module as a regression model using an ensemble method. For example, the server can apply a random forest regressor where each tree estimates a depletion interval given feature vectors derived from usage history. The server trains this model using past depletion events as labels, minimizing a mean squared error loss. The server also may apply exponential smoothing or an autoregressive integrated moving average method as a simpler alternative.

The server writes the predicted depletion date and a confidence score into the depletion forecast table. The server uses this information to determine candidate times for reminder notifications.

By performing these predictions server-side using structured history and statistical models, the system reduces redundant client-side estimation and thereby lowers processing load and memory footprint on the terminal. The centralization of prediction logic also reduces network traffic because fewer raw usage events must be transmitted repeatedly for on-device reasoning.

### F. Notification Management and Technical Effect

The server implements a notification management module that combines depletion forecasts, inventory information, and emotion history to compute notification timing and message expression.

The server reads, for each consumable item, a depletion prediction time and a recommended lead time from the depletion forecast table. The server calculates a candidate reminder time by subtracting the lead time from the depletion prediction time.

The server adjusts the candidate reminder time based on the most recent emotional state from the emotion history table. For example, when the emotion history indicates high stress, the server delays the reminder to a later time window where emotion records historically indicate lower stress. This adjustment is executed according to predetermined rules that reference both time-of-day patterns and emotion scores.

The server optionally invokes the generative AI model to generate a reminder message that is linguistically adapted to the emotion state. The server generates a prompt sentence such as: “Compose a short and friendly reminder message to tell the user that their shampoo is running low and they should consider buying more, without causing stress.”

The server provides this prompt sentence to the generative AI model, decodes the output, and uses the resulting message body as the notification content.

By integrating emotion features and depletion forecasts into a unified notification policy, the server avoids redundant, mistimed reminders that would otherwise require multiple resends and additional client-side filtering. As a result, the server reduces the number of unsuccessful or ignored notifications and improves the efficiency of network communication and server resource usage.

### G. Receipt and Transaction Image Processing

The terminal captures images of receipts or transaction records using the camera. The terminal compresses or encodes the captured frames into an image format and transmits the image data to the server using a secure network protocol.

The server receives the image data and applies optical character recognition processing. The server can use an optical character recognition engine implemented as a convolutional recurrent neural network, which processes line segments of the image, detects characters, and outputs text strings with associated confidence scores.

The server further uses the generative AI model to interpret unstructured text regions and convert them into structured transaction content. The server generates a prompt sentence such as:

“This is text extracted from a shopping receipt. Extract from it a list of purchased items with their names, quantities, and unit prices, and output them as structured descriptions in natural language.”

The server feeds the extracted text and prompt sentence into the generative AI model. The model returns a structured description that identifies item names and quantities. The server then maps the textual description into normalized item entries in the item table, using a semantic matching algorithm that compares the generated descriptions to known canonical item names.

Because the generative AI model is used not merely as a black-box recognizer but as a flexible parser guided by tailored prompt sentences, the system can handle diverse receipt formats and ambiguous abbreviations without enumerating all possible patterns in rules. This reduces the number of manually defined templates and increases the robustness of the system to variations in receipt layouts, thus improving extraction accuracy and decreasing the need for user corrections.

### H. Dynamic Prompt Sentence Generation and Technical Improvement

The server constructs prompt sentences dynamically by combining values read from the transaction table, item table, inventory table, usage history table, and emotion history table. The server uses deterministic templates with variable fields, and in some embodiments uses learned models to select or adjust phrasing based on historical performance. The server may generate, for example, the following prompt sentence for recipe generation:
“The user currently has tomatoes (3 units), mozzarella cheese (1 block), and basil (a small bunch) in inventory. The user feels joyful. Propose an easy and delicious Caprese recipe and an additional sweet dessert recipe that will amplify the user's joy.”

The server may generate the following prompt sentence for leftover usage:
“The user has leftover tomatoes and basil that should be used within 2 days. Propose three recipes that use these ingredients efficiently and minimize food waste.”

The server may generate the following prompt sentence for consumable prediction:
“Using the following purchase dates and quantities of shampoo, estimate the date when the current bottle will be empty, and explain the reasoning briefly.”

By parameterizing the prompt content based on structured data, the server ensures that the generative AI model receives comprehensive context in a single request. This reduces the need for iterative querying and subsequent rule-based combination of partial responses, thereby decreasing processing latency and network overhead. The integration of dynamic prompt construction into the core system, combined with the generative AI model's capacity to perform multi-step reasoning, constitutes an improvement to the functioning of the computer system.

### I. Example System Behavior

The user purchases various items at a store and receives a receipt. The user uses the terminal to capture an image of the receipt and to send the data to the server. The server decodes the image, performs optical character recognition, uses the generative AI model to parse the extracted text into structured item-level data, and stores this data in the item table and transaction table.

The server updates the inventory table to reflect new quantities. Later, the user requests a meal suggestion. The server reads inventory information and the latest emotion record, constructs a prompt sentence, calls the generative AI model, and receives a cooking procedure. The server stores the procedure and transmits it to the terminal, which displays step-by-step instructions. The user prepares the meal according to the instructions and confirms the completion on the terminal. The server deducts used quantities from the inventory table and logs the consumption in the usage history table.

Over time, the server's prediction module computes depletion forecasts for consumable items based on the usage history and transaction patterns, and the notification management module schedules emotion-aware reminder notifications. The server occasionally uses the generative AI model to produce friendly, context-aware reminder messages based on constructed prompt sentences.

Because the server centralizes control of image processing, generative inference, structured data management, prediction, and notification logic, and because these components are tightly integrated through specific data structures and algorithms, the system operates with increased computational efficiency and improved technical performance compared to systems in which such functions are dispersed across independent applications and manual workflows.

### J. Alternative Embodiments

The server may implement different variants of the generative AI model, such as an encoder-decoder transformer or a sequence-to-sequence recurrent network, provided that the model can consume prompt sentences and output natural language or structured text. The server may adjust the architecture depth, the number of attention heads, and the size of hidden layers to balance accuracy and processing speed.

The server may vary the emotion analysis engine implementation, using cloud-based services or on-premise models, as long as the engine outputs an emotion representation that can be stored in the emotion history table and incorporated into prompt sentences and scheduling rules.

The server may use alternative machine learning models for depletion prediction, such as gradient boosting trees or neural networks for time-series forecasting. The server may augment feature sets with contextual data such as calendar events, thereby refining prediction accuracy while keeping the core data structures compatible with the claims.

The terminal may optionally perform some preprocessing, such as local compression of image data, noise reduction, or partial optical character recognition, and then transmit intermediate results to the server. However, in all embodiments, the server remains responsible for integrating these data into the claimed unified processing pipeline that uses generative AI and dynamically generated prompt sentences.

Through these embodiments and variations, the system uses specific data structures, learning algorithms, and coordinated modules to process real-world receipt images, manage inventory and financial data, generate context-aware content, and schedule emotion-aware notifications. This cooperation yields technical effects including reduced latency, improved extraction accuracy, decreased communication overhead, more efficient storage utilization, and enhanced adaptability, which together represent an improvement to computer technology beyond mere automation of a known business practice.

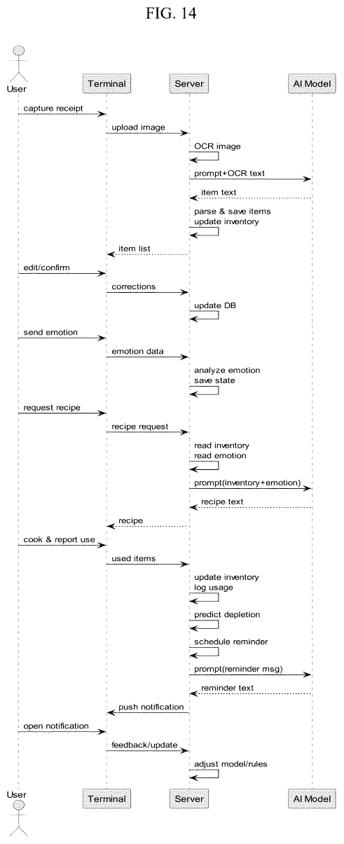

The following describes the processing flow using FIG. 14.

### Step 1

Terminal captures receipt image and sends it to Server.

Terminal receives, as input, a physical receipt presented by User and camera sensor data. Terminal activates a camera application programming interface, displays a preview, and allows User to frame the receipt. Terminal converts the captured scene into digital image data in a format such as JPEG or PNG. Terminal attaches metadata including a timestamp and a user identifier to the image data. Terminal transmits, as output, an HTTP request containing the image data and the metadata to Server over a secure protocol.

User provides, as input, the physical receipt and a capture instruction. User places the receipt on a flat surface, points the camera of Terminal at the receipt, and taps a capture button. Server receives, as input, the HTTP request from Terminal that includes the image binary and metadata. Server validates the content type and file size, assigns a unique image identifier, and stores the image in a storage unit such as an object storage system. Server outputs a storage reference and a processing job record indicating that the receipt image is ready for further analysis.

### Step 2

Server performs OCR and basic text extraction from the receipt image. Server takes, as input, the stored receipt image and its identifier. Server invokes an optical character recognition engine implemented, for example, as a convolutional recurrent neural network, and passes the image pixels as an input tensor. Server performs data preprocessing including grayscale conversion, normalization, and segmentation of text regions. Server computes, as output, multiple text strings with associated coordinates and confidence scores, representing lines and blocks on the receipt. Server stores the raw recognized text in an intermediate text field linked to the image identifier.

### Step 3

Server transforms OCR text into structured transaction text and calls the generative AI model with a prompt sentence.

Server receives, as input, the raw OCR text and metadata such as store name, date, and total amount. Server cleans the text by removing low-confidence segments, headers, and footers using thresholding and pattern matching. Server concatenates relevant lines into a single normalized text block. Server generates, as input to a generative AI model, a prompt sentence such as: “This is text extracted from a shopping receipt. Extract from it a list of purchased items with their names, quantities, and unit prices, and describe them clearly in natural language.”

Server forms a combined input consisting of the prompt sentence followed by the normalized OCR text. Server tokenizes this combined input using a tokenizer associated with the generative AI model, converting characters into token indices. Server feeds, as input to the generative AI model, the token sequence and configuration parameters such as a maximum output length and a temperature value.

Server receives, as output from the generative AI model, a generated text sequence that describes the purchased items, quantities, and prices in a clearer format. Server decodes token indices back into characters to obtain natural-language structured descriptions. Server stores this generated text as an intermediate structured description associated with the original image.

### Step 4

Server converts generated descriptions into item records and updates transaction and inventory tables.

Server receives, as input, the generated descriptions of purchased items and the original transaction metadata (user identifier, timestamp). Server parses the generated text by applying pattern matching and simple grammar rules to identify item names, quantities, units, and unit prices. Server maps item names to canonical item identifiers by comparing the extracted names with entries in a master item dictionary using a similarity metric or lookup table.

Server outputs, as item records, structured data objects that include user identifier, transaction identifier, item identifier, normalized item name, quantity, unit, and unit price. Server writes these item records into an item table and writes a summary transaction record into a transaction table.

Server further updates, as output, an inventory table by increasing the current quantity for each relevant item and setting or updating an expiration date if applicable. Server logs the completed update so that subsequent modules can query accurate inventory and accounting information.

### Step 5

Terminal displays recognized items and allows User corrections.

Terminal requests, as input, the structured item records and generated descriptions from Server once Server signals completion. Terminal receives the item list and displays, as output, a user interface including item names, quantities, and prices in tabular form.

User reviews, as input, the displayed list, compares it with the physical receipt, and performs corrections when necessary. User edits, for example, a misrecognized item name or quantity by typing into fields or selecting from suggestion lists and then taps a confirm button. Terminal sends, as output, the corrected item data to Server via an HTTP request. Server receives, as input, the corrected data, replaces or merges the corresponding item records in the item table, and recalculates transaction totals and inventory quantities to maintain consistency. Server outputs updated tables with corrected information.

### Step 6

Server records usage history and maintains up-to-date inventory information.

Server receives, as input, signals from Terminal indicating that User has consumed or used certain items, for example after cooking or daily use. These signals include item identifiers and used quantities.

Server updates, as output, the inventory table by decrementing the current quantity columns for the specified items. Server writes a new row into a usage history table with fields for user identifier, item identifier, used quantity, timestamp, and context information (e.g., “recipe use,” “daily use”).

Server performs data checks to prevent negative quantities, and if an item's quantity falls below a threshold, Server flags the item as low-stock. Server outputs an updated inventory state that will be used as input to subsequent planning and prediction processes.

### Step 7

Terminal and User provide emotion-related input for emotion analysis.

Terminal receives, as input, user interactions such as voice recordings, camera images, or text entries whenever User chooses to report their emotional state or when prompted. Terminal uses a microphone module to capture audio, a camera module to capture image frames of the user's face, or text fields to capture typed input like “I feel stressed.” Terminal preprocesses the raw signals, such as compressing audio and resizing images, and transmits, as output, the processed voice information, image information, or text information to Server along with a user identifier and timestamp.

User explicitly or implicitly provides, as input, the emotional information by speaking, appearing on camera, or entering text.

### Step 8

Server analyzes emotion data and stores emotion features.

Server receives, as input, the user's voice, image, or text data from Terminal. Server passes the audio to a speech-feature extractor to compute acoustic features; passes the image to a face analysis module to compute visual features; or passes the text to a language model to compute semantic features.

Server feeds, as input, the extracted features into an emotion analysis engine, which can be a neural network classifier trained to produce probabilities for emotions such as joy, stress, anger, and neutrality. Server computes, as output, an emotion state vector containing emotion labels and numeric scores.

Server writes the emotion state vector, as output, into the emotion history table along with the user identifier and timestamp. Server exposes the latest emotion state as an input for prompt sentence generation and notification scheduling.

### Step 9

Server generates a prompt sentence for recipe or plan creation based on inventory and emotion.

Server reads, as input, the current inventory table for a user, the latest emotion state from the emotion history table, and optional context such as time of day. Server selects a subset of available items that are suitable for cooking (e.g., ingredients with non-zero quantities and valid expiration dates).

Server composes, as output, a prompt sentence for a generative AI model that encodes the inventory and emotion information in natural language. For example, Server may generate: “The user currently has tomatoes (3 units), mozzarella cheese (1 block), and basil (a small bunch) in inventory. The user feels joyful. Propose an easy and delicious Caprese recipe and an additional sweet dessert recipe that will amplify the user's joy.”

Server tokenizes this prompt sentence, and optionally appends additional structured textual data representing quantities or dietary constraints, producing an input token sequence for the generative AI model.

### Step 10

Server calls the generative AI model to obtain a cooking procedure or consumption plan. Server provides, as input, the tokenized prompt sentence and generative configuration parameters to the generative AI model. Server runs the model to compute attention weights, intermediate representations, and next-token probabilities layer by layer in the neural network.

Server samples or selects tokens according to the model's output distributions, producing, as output, a token sequence that represents at least one cooking procedure or consumption plan. Server decodes the sequence into a human-readable text description, which includes ingredient lists, ordered steps, estimated cooking time, or a schedule for consuming items.

Server stores the generated content in the generated content table, associating it with the prompt sentence and input data. Server outputs the generated cooking procedure or consumption plan to Terminal for user presentation.

### Step 11

Terminal displays generated content and User executes or adjusts it.

Terminal receives, as input, the cooking procedure or consumption plan text and metadata from Server. Terminal formats, as output, the content into a user interface that lists required items, step-by-step instructions, and timing information.

User reviews, as input, the displayed content, chooses a recipe or plan, and follows the steps in the real world, such as preparing a dish or scheduling consumption of items. User may modify steps, skip steps, or provide feedback through the Terminal interface indicating whether the recipe was helpful or whether certain instructions were unclear.

Terminal captures this feedback and sends, as output, feedback data to Server, which records it for potential adaptation of future prompt sentences or model tuning.

### Step 12

Server updates inventory and usage history based on executed procedures or plans.

Server receives, as input, signals from Terminal indicating that User has completed a selected cooking procedure or has followed a consumption plan. These signals include a reference to the generated content and reported item usage.

Server computes, based on the recipe's ingredient list and user feedback about substitutions or omissions, the actual quantities of items consumed. Server updates, as output, the inventory table by subtracting these quantities from current quantities for each item. Server writes new entries into the usage history table recording the link between the generated content and the consumption event.

Server may compute summary statistics, such as frequency of using specific items or types of recipes, and store them for later use in prediction and personalization.

### Step 13

Server predicts depletion of consumable items using statistical and machine learning models.

Server reads, as input, the usage history table and item table for consumable items. Server aggregates consumption events into time series, computing features such as average daily consumption, variance, and seasonal patterns for each consumable.

Server feeds these features, as input, into a depletion prediction model, for example a random forest regressor. The model applies decision-tree ensembles to estimate the remaining lifetime of each consumable. Server calculates, as output, a depletion prediction time (expected run-out date) and a confidence score for each item.

Server writes the prediction results to the depletion forecast table and exposes, as output, the predicted depletion dates for use by the notification management module.

### Step 14

Server determines reminder timing and generates reminder messages using emotion-aware rules and prompt sentences.

Server receives, as input, depletion predictions from the depletion forecast table and the latest emotion states from the emotion history table. Server computes candidate reminder times by subtracting recommended lead times from predicted depletion dates.

Server adjusts, as output, the reminder timing according to the emotion state. For example, if the user's emotion state indicates stress, Server delays the reminder within a predefined window; if the emotion state indicates calmness, Server retains or advances the reminder to ensure timely action.

Server optionally generates a prompt sentence for the generative AI model such as: “Compose a short and friendly reminder message to tell the user that their shampoo is running low and they should consider buying more, without causing stress.”

Server feeds this prompt sentence, as input, into the generative AI model and obtains, as output, a natural-language reminder message. Server stores the reminder message in the generated content table and schedules it for delivery at the computed reminder time.

### Step 15

Server sends notifications and Terminal presents them to User.

Server monitors, as input, the system clock and scheduled reminder times. At each appropriate time, Server collects the relevant notification content and the target user identifier. Server transmits, as output, a push notification message through a push notification service to Terminal, including a title, body text, and metadata such as an item identifier and urgency flag.

Terminal receives, as input, the push notification from the network. Terminal displays, as output, the notification in a notification bar or as an in-app alert. When User taps the notification, Terminal opens a detail screen that may show the depletion prediction time, current stock, and a call-to-action to purchase or update inventory.

User receives, as input, the reminder, decides whether to purchase or ignore it, and may update the inventory status through the Terminal interface. Terminal sends, as output, any updates or user responses back to Server, which logs them in a reminder history table and adjusts future prediction and scheduling parameters accordingly.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

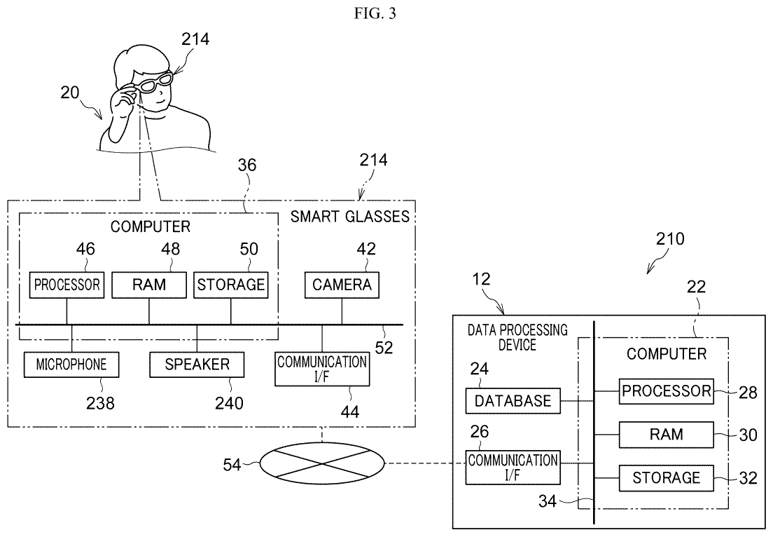

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

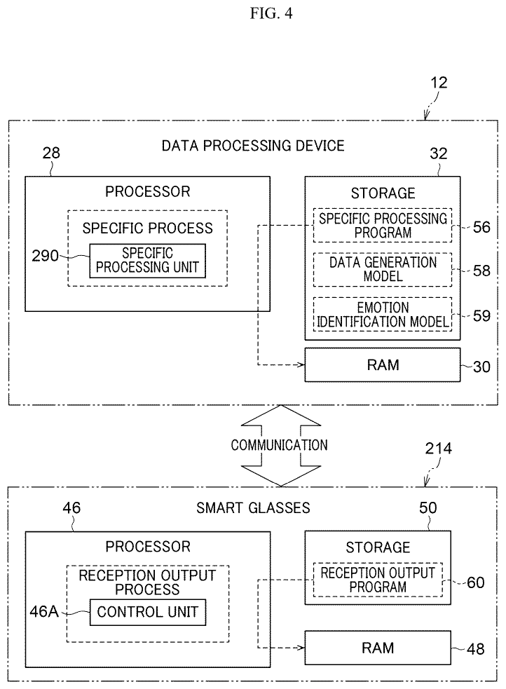

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

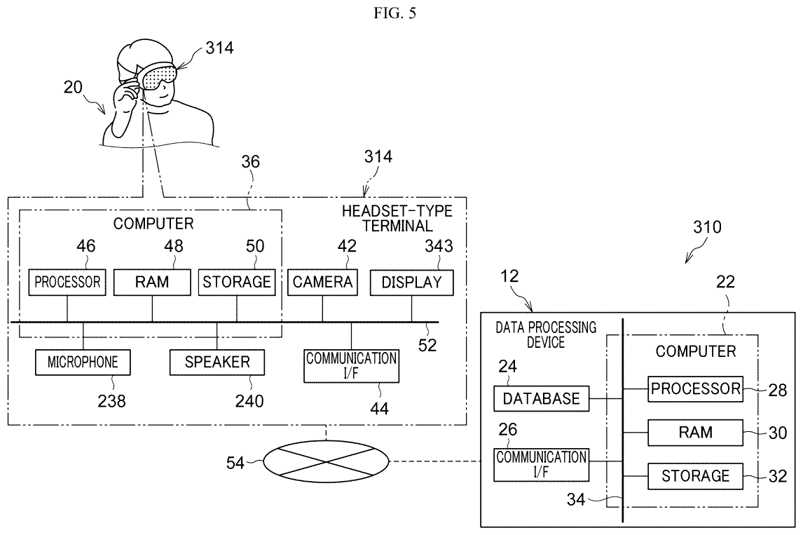

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

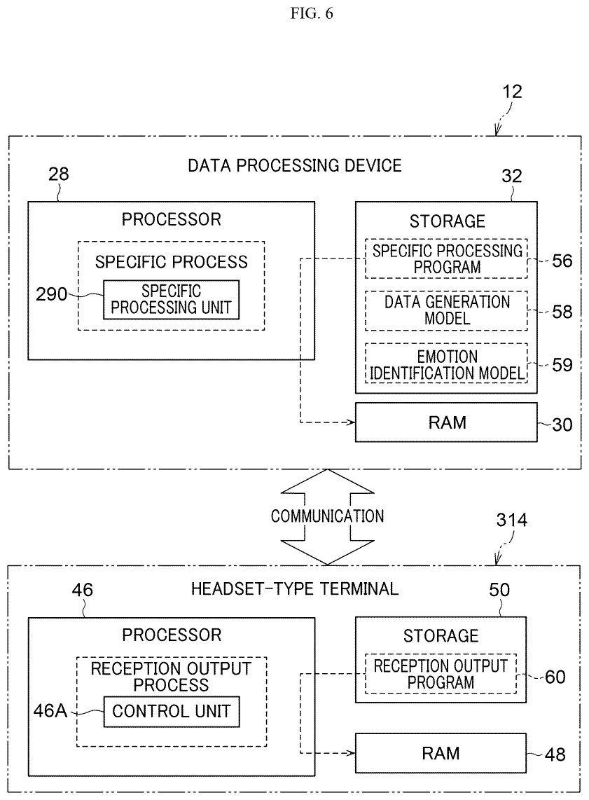

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

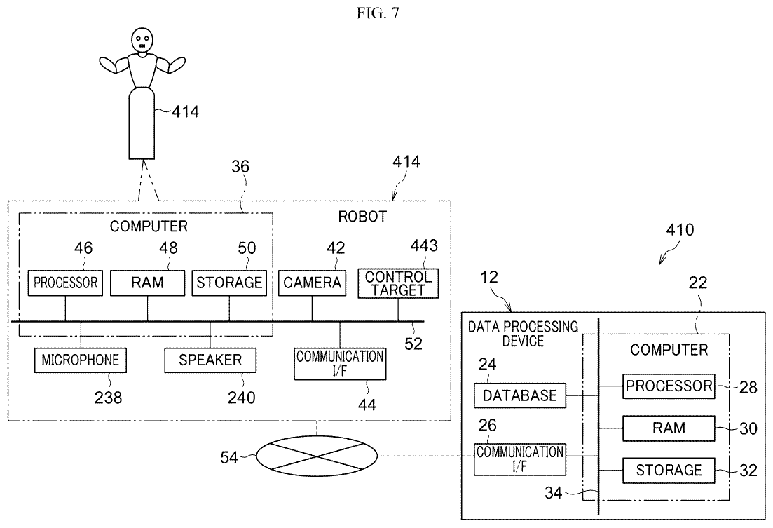

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

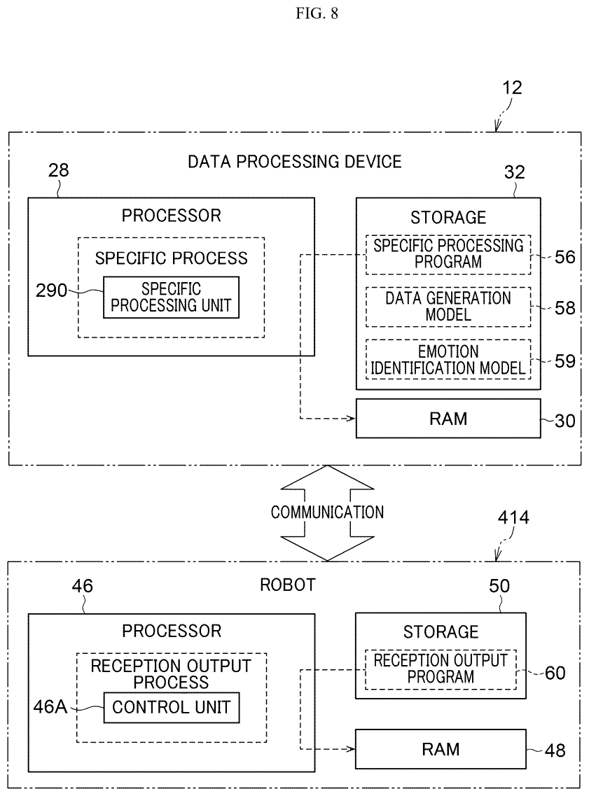

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

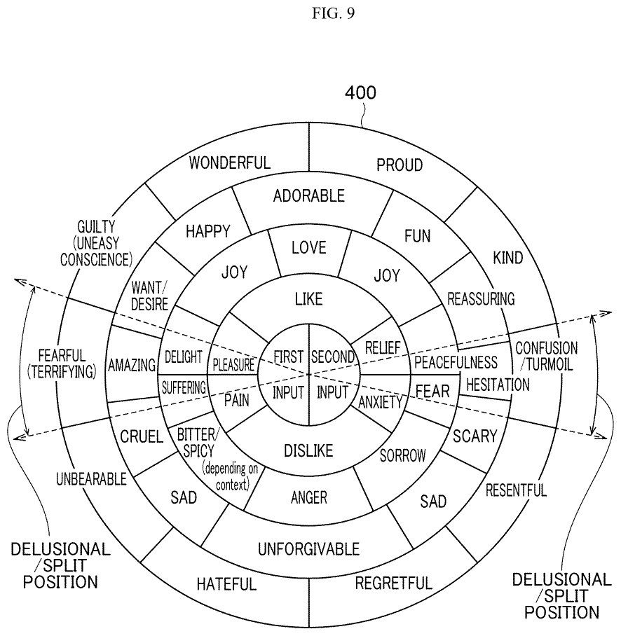

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

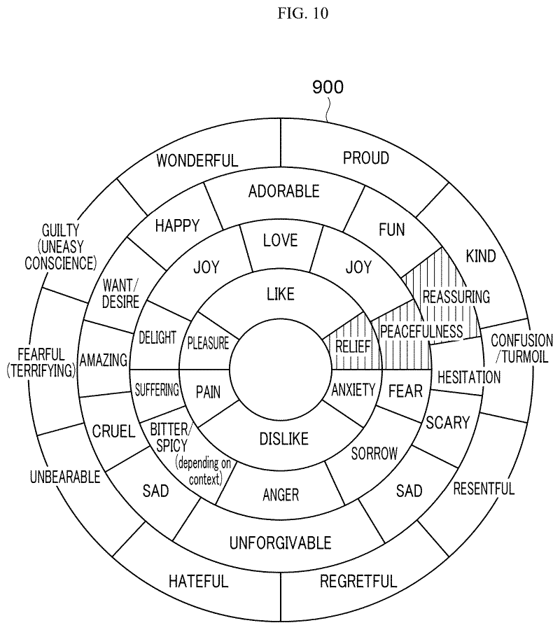

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire and record transaction-related information of a user, and
perform preprocessing on image data of a transaction proof acquired by an image input device, generate a prompt sentence for causing a generative AI model to read the image data of the transaction proof, and control input of the prompt sentence and the image data into the generative AI model, and
perform character recognition processing and structural analysis processing on character information output from the generative AI model, extract purchased items, quantities, and prices from the character information, and update resource management information on the basis of the extracted items and quantities, and
select a combination of items available for cooking from the resource management information, generate a prompt sentence for instructing the generative AI model to generate a cooking procedure on the basis of the combination of the items and attribute information or preference information of the user, and control input of the prompt sentence into the generative AI model, and
format information relating to the cooking procedure output from the generative AI model into a predetermined format, calculate consumption amounts of resources corresponding to the cooking procedure, update the resource management information on the basis of the consumption amounts, and output the cooking procedure to an information display device.

### (Supplementary 2)

The system according to supplementary 1,
wherein the processor is configured to
predict future shortages of resources on the basis of the resource management information and the information relating to the cooking procedure, generate a prompt sentence for instructing the generative AI model to generate proposal information on the basis of predicted shortage resources and behavior history or state information of the user, determine notification content and transmission timing in accordance with the proposal information, and
output the notification content at the determined transmission timing to the information display device or a notification device.

### (Supplementary 3)

The system according to supplementary 1,
wherein the processor is configured to
dynamically configure the prompt sentence input to the generative AI model by combining a plurality of kinds of information including item names and quantities extracted from the image of the transaction proof, the resource management information, the attribute information or preference information of the user, cooking condition information, and notification condition information, verify a structure and items of an output result from the generative AI model, and, when a deficiency is detected, automatically correct the prompt sentence and re-input the corrected prompt sentence to the generative AI model.

### Application Example 1

### (Supplementary 1)

A system comprising a processor,
wherein the processor is configured to
acquire transaction information of a user and record the transaction information as household management information, and
receive image data of a transaction evidence document captured by an imaging device, extract character string data from the image data by using an image processing unit and a character recognition unit, generate a prompt sentence including the character string data, and input the prompt sentence into a generative artificial intelligence model so as to cause the generative artificial intelligence model to extract item information of purchased articles as normalized item names, quantities, and units, and
store the extracted item information as inventory management information, generate, based on the inventory management information and past usage history information, a prompt sentence for causing the generative artificial intelligence model to generate cooking procedure information using inventory items, input the prompt sentence into the generative artificial intelligence model, acquire the cooking procedure information output from the generative artificial intelligence model, and provide the cooking procedure information to a user terminal, and
specify items predicted to become insufficient in the future based on the inventory management information and the usage history information, generate notification information regarding the predicted insufficient items, and transmit the notification information to the user terminal, and
generate order information to an external information processing apparatus for a delivery service based on at least one of the cooking procedure information and the inventory management information, transmit the order information to the external information processing apparatus, and thereby enable ordering of prepared food for delivery.

### (Supplementary 2)

The system according to supplementary 1,
wherein the processor is configured to classify the item information extracted from the character string data into expenditure category information as household management information, record the expenditure category information, and provide, to the user terminal, an aggregation result based on the expenditure category information.

### (Supplementary 3)

The system according to supplementary 1,
wherein the processor is configured to extract, from the inventory management information, items having an expiration date approaching and items having a remaining amount equal to or smaller than a threshold, generate a prompt sentence for causing the generative artificial intelligence model to generate cooking procedure information that preferentially uses the extracted items so as to suppress food waste, input the prompt sentence into the generative artificial intelligence model, acquire the cooking procedure information output from the generative artificial intelligence model, and provide the cooking procedure information to the user terminal.

### Example 2

### (Supplementary 1)

A system comprising a processor,
wherein the processor is configured to
acquire and record information relating to economic activities of a user,
extract character information from an image of a document medium and generate, on the basis of the extracted character information, attribute information and quantity information of purchased target objects,
update, on the basis of the attribute information and the quantity information of the target objects, inventory information for each of the target objects that is stored in an information storage unit,
generate a prompt sentence that is configured to preferentially utilize the inventory information, on the basis of the inventory information and information regarding remaining target objects that is input by the user,
input the prompt sentence and the attribute information and the quantity information of the target objects into a generative artificial intelligence model and instruct the generative artificial intelligence model to generate procedure information using the target objects,
acquire the procedure information output from the generative artificial intelligence model, record the prompt sentence and the procedure information in association with each other in the information storage unit, and provide the procedure information to a user terminal,
update the inventory information on the basis of the inventory information and usage amounts of the target objects included in the procedure information,
analyze consumption tendencies of the target objects on the basis of the inventory information and past usage history of the user and extract shortage prediction target objects that satisfy a predetermined threshold, and
generate notification information regarding the shortage prediction target objects and transmit the notification information to the user terminal.

### (Supplementary 2)

The system according to supplementary 1,
wherein the processor is configured to
convert, by using the character information extracted from the image of the document medium, for each purchased target object, the attribute information into standardized name information and unit information into standardized unit information, and manage the inventory information hierarchically on the basis of the standardized name information and the standardized unit information.

### (Supplementary 3)

The system according to supplementary 1,
wherein the processor is configured to
analyze, in generating the notification information regarding the shortage prediction target objects, a response history of the user to past notifications and a utilization history of the procedure information, and dynamically change a transmission timing and content of the notification on the basis of an analysis result.

### Application Example 2

### (Supplementary 1)

A system comprising a processor,
wherein the processor is configured to
acquire and record transaction information of a user,
acquire image data of a receipt or a transaction record from a user terminal, generate a prompt sentence that instructs a generative AI model to perform image recognition processing for extracting transaction content from the image data, and input the image data and the prompt sentence into the generative AI model,
obtain analysis results from the generative AI model, identify purchased items based on the analysis results, and store the purchased items as inventory information and accounting information in one or more storage units,
extract available items based on the inventory information, generate a prompt sentence that reflects a current emotional state and a usage situation of the user, input the prompt sentence into the generative AI model, and thereby generate, from the generative AI model, at least one of a cooking procedure and a consumption plan that uses the available items,
update the inventory information based on the generated cooking procedure or the generated consumption plan, and reflect remaining items in one or more subsequent cooking procedures or consumption plans,
identify, based on a usage history and the inventory information of consumable items, one or more items predicted to become insufficient, generate notification content regarding the one or more items predicted to become insufficient, and transmit the notification content to the user terminal,
acquire at least one of voice information, image information, and text information of the user,
estimate the emotional state of the user by using an emotion analysis engine based on the acquired information, and adjust at least one of the notification content, a notification timing, and a content of the cooking procedure or the consumption plan in accordance with the emotional state.

### (Supplementary 2)

The system according to supplementary 1,
wherein the processor is configured to perform optical character recognition processing on the image data of the receipt or the transaction record received from the user terminal, combine an output of the optical character recognition processing with an output of the generative AI model, extract at least an item name, a quantity, and a purchase date of each purchased item, record the extracted information in both a financial management database and an inventory management database in association with each other, and dynamically generate the prompt sentence based on a content of the inventory management database.

### (Supplementary 3)

The system according to supplementary 1,
wherein the processor is configured to analyze, for each consumable item, a purchase history and a usage history, calculate a depletion prediction time for each consumable item by using at least one of a machine learning algorithm and a statistical processing method, determine a transmission time and a message expression of a reminder notification based on the depletion prediction time and the emotional state of the user, and, when necessary, generate a prompt sentence that instructs the generative AI model to generate a reminder message and input the prompt sentence into the generative AI model to obtain the reminder message.

What is claimed is:

1. A system comprising:
circuitry configured to:
receive, via a communication interface coupled to a packet-switched network, image data of a transaction proof from a terminal device, and perform preprocessing on the image data;
generate a first prompt sentence for causing a generative neural network model to process the image data, and input the first prompt sentence and the image data to the generative neural network model;
perform character recognition processing and structural analysis processing on character information output from the generative neural network model to extract item identifiers, quantity values, and price values, and update resource management data stored in a storage device based on the extracted item identifiers and quantity values;
select a combination of item identifiers available for a target process from the resource management data, generate a second prompt sentence encoding the combination of item identifiers and user preference data, and input the second prompt sentence to the generative neural network model to generate procedure output data;
format the procedure output data into a predetermined output format, calculate consumption values corresponding to the procedure output data, update the resource management data based on the consumption values, and transmit the formatted procedure output data to the terminal device via the communication interface; and
predict future depletion of resource items based on the resource management data, generate a third prompt sentence encoding predicted depletion data and user behavior history data, input the third prompt sentence to the generative neural network model to generate notification proposal data, and transmit notification content at a determined transmission timing to the terminal device.

2. The system according to claim 1, wherein the circuitry is configured to perform the preprocessing by applying an image normalization algorithm to the image data to produce a normalized image, and to generate the first prompt sentence by constructing an instruction text that specifies a structured output format for item identifiers, quantity values, and price values.

3. The system according to claim 2, wherein the circuitry is configured to perform the structural analysis processing by applying a parsing algorithm to the character information to identify line items, and to extract the item identifiers, quantity values, and price values by mapping parsed line item fields to corresponding structured data fields.

4. The system according to claim 2, wherein the image data comprises an image of a purchase receipt, the item identifiers comprise names of purchased food items and household consumables, and the procedure output data comprises a cooking recipe procedure for preparing a meal using the selected combination of item identifiers.

5. The system according to claim 4, wherein the circuitry is configured to select the combination of item identifiers by querying the resource management data to identify items with a quantity value above a minimum threshold, and to generate the second prompt sentence by incorporating the selected item identifiers and the user preference data comprising at least one of a dietary preference or a cooking skill level.

6. The system according to claim 1, wherein the circuitry is configured to predict the future depletion of resource items by applying a depletion prediction model to the resource management data and usage history data stored in the storage device to compute a predicted depletion timeline for each resource item.

7. The system according to claim 6, wherein the circuitry is configured to analyze an emotional state of a user from input data received from the terminal device, and to determine the transmission timing of the notification content based on the predicted depletion timeline and the analyzed emotional state.

8. The system according to claim 7, wherein the circuitry is configured to apply an emotion identification model to the input data to output a probability distribution over a plurality of emotional state categories, and to delay or advance the transmission timing based on whether the probability distribution indicates a stress-associated emotional state.

9. The system according to claim 1, wherein the circuitry is configured to dynamically configure the second prompt sentence by combining the item identifiers and quantity values extracted from the image data, the resource management data, the user preference data, and a cooking condition parameter specifying at least one of a preparation time constraint or a serving count.

10. The system according to claim 9, wherein the circuitry is configured to update the second prompt sentence based on dialogue history data comprising prior procedure output data stored in the storage device, and to incorporate the dialogue history data as additional context in the second prompt sentence.

11. The system according to claim 1, wherein the circuitry is configured to format the procedure output data by parsing the procedure output data to identify step-level segments, assigning each segment a step identifier and an estimated preparation duration, and storing the formatted procedure output data in a predetermined structured format in the storage device.

12. The system according to claim 1, wherein the circuitry is configured to calculate the consumption values by parsing the procedure output data to extract ingredient quantity specifications, converting the extracted ingredient quantity specifications to a common unit using a unit conversion table, and subtracting the converted consumption values from corresponding quantity values in the resource management data.

13. The system according to claim 1, wherein the circuitry is configured to record transaction-related data received from the terminal device in the storage device, and to update the resource management data by adding the extracted item identifiers and quantity values as new inventory entries or by incrementing existing inventory entries matching the extracted item identifiers.

14. The system according to claim 1, wherein the circuitry is configured to generate the notification proposal data by encoding the predicted depletion data and the user behavior history data in the third prompt sentence, and to extract a notification timing recommendation and a notification message from the notification proposal data output by the generative neural network model.

15. The system according to claim 14, wherein the circuitry is configured to determine the transmission timing by comparing the notification timing recommendation against a schedule constraint derived from the user behavior history data, and selecting the earliest transmission time satisfying both the notification timing recommendation and the schedule constraint.

16. The system according to claim 1, wherein the circuitry is configured to generate a plurality of procedure output candidates by executing the generative neural network model a plurality of times using varied sampling parameters, and to select a highest-scored candidate based on a scoring metric that measures alignment between the procedure output candidate and the user preference data.

17. The system according to claim 1, wherein the circuitry is configured to monitor a resource item depletion rate by computing a rate of change of the quantity values in the resource management data over time, and to trigger depletion prediction when the rate of change for a resource item exceeds a depletion rate threshold.

18. A system comprising:
circuitry configured to:
receive, via a communication interface coupled to a packet-switched network, image data of a transaction proof from a terminal device;
perform preprocessing on the image data, generate a first prompt sentence, and input the first prompt sentence and the image data to a generative neural network model to generate character information;
apply character recognition and structural analysis to the character information to extract item identifiers, quantity values, and price values, and update resource management data in a storage device;
select a combination of item identifiers from the resource management data, generate a second prompt sentence encoding the combination and user preference data, and execute the generative neural network model to generate and transmit formatted procedure output data;
predict resource item depletion from the resource management data, generate a third prompt sentence encoding depletion predictions and user behavior history, and output notification content at a timing determined from the third prompt sentence output.

19. The system according to claim 18, wherein the circuitry is configured to analyze an emotional state of a user from input data received from the terminal device, apply an emotion identification model to generate an emotional state indicator, and adjust the notification transmission timing based on the emotional state indicator.

20. A method comprising:
receiving, via a communication interface coupled to a packet-switched network, image data of a transaction proof from a terminal device, and performing preprocessing on the image data;
generating a first prompt sentence for causing a generative neural network model to process the image data, and inputting the first prompt sentence and the image data to the generative neural network model;
performing character recognition processing and structural analysis processing on character information output from the generative neural network model to extract item identifiers, quantity values, and price values, and updating resource management data stored in a storage device based on the extracted item identifiers and quantity values;
selecting a combination of item identifiers available for a target process from the resource management data, generating a second prompt sentence encoding the combination of item identifiers and user preference data, and inputting the second prompt sentence to the generative neural network model to generate procedure output data;
formatting the procedure output data into a predetermined output format, calculating consumption values corresponding to the procedure output data, updating the resource management data based on the consumption values, and transmitting the formatted procedure output data to the terminal device via the communication interface; and
predicting future depletion of resource items based on the resource management data, generating a third prompt sentence encoding predicted depletion data and user behavior history data, inputting the third prompt sentence to the generative neural network model to generate notification proposal data, and transmitting notification content at a determined transmission timing to the terminal device.
